(19) United States
(12) Patent Application Publication
(10) Pub. No.: US 2002/0050714 A1
(43) Pub. Date: May 2, 2002

(54) Original document indication creating device and hot stamp unit

(76) Inventors: Eiji Imai, Suwa-gun (JP); Mamoru Matsuda, Suwa-gun (JP); Yukio Kuroiwa, Suwa-gun (JP)

Correspondence Address: Eugene LeDonne, Esq., Reed Smith LLP, 375 Park Ave. 17th Floor, New York, NY, 10152, US

(21) Appl. No.: 09/872,563

(22) Filed: Jun. 1, 2001

(30) Foreign Application Priority Data
Jun. 2, 2000 (JP) 2000-166752

(51) Int. Cl. B42D 15/00

(52) U.S. Cl. 283/74

(57) ABSTRACT

The present invention provides for an original document indication device. The device contains a document creating portion for creating a document on a medium; a counterfeit countermeasure transferring portion for creating an original document indication on the medium; a transporting means for transporting the medium; and a controlling portion for controlling operation of the document creating portion, the counterfeit countermeasure transferring portion and the transporting means based on signals which are input from an operating portion; wherein an original document indication is created as the medium is transported by the transporting means through the document creating portion and the counterfeit countermeasure transferring portion.

### RELATED PATENTS AND APPLICATIONS

This application claims priority of Japanese Patent Application No. 2000-166752 filed on Jun. 2, 2000, the complete disclosure of which is hereby incorporated by reference.

1. Field of the Invention

The present invention relates to an original document indication device and a hot stamp unit. More specifically, the present invention relates to an original document indication creating device in which a predetermined original document indication is created on a medium such as a paper document with written sentences, letters, figures, tables, etc. to indicate the authenticity of the document and prevent a counterfeit.

In addition, the present invention relates to an improvement of the internal structure of an original document indication.

2. Background of the Invention

In recent years, electronic documents (files) such as e-mail (electronic mail) have been widely used, however, paper documents created by a printer or a copier are still highly in demand and serve as the original documents. Also, as a result of ISO9000 and ISO14000, management of original paper documents has become more important.

FIG. 34 shows conventional methods used to distinguish an original document from a copy such as providing a stamp 101 on a document, handwriting a signature and creating a document on a special paper with a counterfeit countermeasure. Another method includes applying a special sticker 102 to an original document. Another method includes overlaying a document with an original document indication using a copier 103 or printer 104.

However, these methods have limitations. For example, creating an original document indication using a stamp 101 has the following limitations: (1) the simple stamp 101 can be easily counterfeited; (2) frequent use makes it difficult to manage the stamp 101 and the stamp 101 can be accessed easily by anyone; (3) it is troublesome to copy a document and then apply a stamp; and (4) it is possible to counterfeit the document with a color copy.

In addition, creating an original document indication using a sticker 102 has the following limitations: (1) it is difficult to manage the sticker 102 as anyone can access the sticker 102; and (2) the sticker 102 can be pealed off. Also, creating an original document indication by handwriting a signature can be imitated or copied, is troublesome and limits the authority thereby delaying the business.

Furthermore, providing an original document indication by these methods is a separate and additional task from printing letters, figures and tables on a document medium.

Also, an original document indication that is created by overlaying a document with an original document indication using a copier 103 or printer 104 can be copied and duplicated by the same machine even if a password is set for security. Also, creating an original document indication with special paper increases the cost.

Therefore, one of the purposes of the present invention is to provide an original document indication device that maintains a convenient connection with a printer or copier and creates an original document indication with a counterfeit countermeasure.

Another purpose of the present invention is to provide a hot stamp unit in which security of the replacement cartridge is increased.

### SUMMARY OF THE INVENTION

It has now been discovered that these purposes, among others, can be achieved by the present invention. In particular, the present invention provides for an original document indication device including a document creating portion for creating a document on a medium, a counterfeit countermeasure transferring portion for creating an original document indication on the medium, a transporting means for transporting the medium, and a controlling portion for controlling the operation of the document creating portion, the counterfeit countermeasure transferring portion and the transporting means based on signals which are input from an operating portion, wherein an original document indication is created as the medium is transported by the transporting means through the document creating portion and the counterfeit countermeasure transferring portion.

In this original document indication device, the document creating portion and the counterfeit countermeasure transferring portion are linked by a command from the controlling portion. To create an original document indication, a medium is transported in a series of operations and an original document indication is stamped by the counterfeit preventing means during the operations which may be printing or copying of the document and outputting the document to issue a document with a distinguishing indication as the original document. Therefore, a printer or a copier can issue a document with a counterfeit countermeasure identification indication on demand while retaining its convenient printing or copying function.

In particular, a reflective foil medium such as a hologram is preferably thermal-transferred as the counterfeit preventing means. As such, a thermal transferring unit (hot stamp unit) may be incorporated with a printer or copier to transfer the foil onto the printed paper document. This creates a paper document which can be easily identified as the original document and which is difficult to counterfeit. It is also contemplated that an original document indication can be created using various counterfeit preventing means such as overlaying, providing a stamp, etc.

Preferably, the counterfeit countermeasure transferring portion includes a hot stamp unit having a cartridge. As such, both a document and an original document indication can be created in a series of operations from printing the document to thermally transferring the foil by hot stamping. Moreover, since the hot stamp unit is of a cartridge type, the foil can be changed by replacing the cartridge.

In a preferred embodiment of an original document indication device of the present invention, a second original document can be created from a first original document which is saved in an electronic file. Like a resident card, for example, an original document is saved in an electronic file and can be printed on demand. The printed original document is sealed to certify the issue. As such, when a second original document needs to be issued, a second original document with high security can be issued while the convenient function of a printer or copier is retained.

The present invention also provides for a hot stamp unit including a cartridge having identification codes. In this hot stamp unit, the authenticity of the cartridge can be determined by verification between the device and the cartridge or verification during the operation of the copier using the identification codes. Thus, high security can be obtained.

The hot stamp unit of the present invention which includes a cartridge with an identification code such that the authenticity thereof can be verified, can be used as a counterfeit countermeasure transferring portion in an original document indication device. As such, the hot stamp unit can identify a replaceable cartridge to automatically determine if a legal cartridge is properly used. This prevents a legal cartridge from being used in illegal machines and prevents a counterfeit of an original document indication during the counterfeit countermeasure transferring. Security can be obtained through verification between the original document indication device and a cartridge or verification during the copying operation. Also, the distribution of a cartridge can be administered by identifying the identification code such as the identification tag.

### BRIEF DESCRIPTION OF THE DRAWINGS

FIG. 1 shows a copier and the configuration for an original document indication device of the present invention in the copier.

FIG. 2 is an example of an operation panel for use on an operating portion on a copier.

FIG. 3 is a chart showing the operation of a hot stamp unit as a counterfeit countermeasure transferring portion.

FIG. 4 shows the main body of a hot stamp unit including identification codes on a cartridge.

FIG. 5 shows the cartridge of a hot stamp unit and a setting device for setting the code data.

FIG. 6 is a flowchart showing an example operation of an original document indication device (copier).

FIG. 7 shows the configuration of the hot stamp unit of the present invention.

FIG. 8 is a perspective view of the hot stamp unit of the present invention.

FIG. 9 is a front view of the internal configuration of the hot stamp unit of the present invention.

FIG. 10 is a side view of the internal configuration of the hot stamp unit of the present invention.

FIG. 11 shows the internal configuration of the hot stamp unit of the present invention when it is idle.

FIG. 12 shows the positional relationship between a stopper and a stopper lever when the hot stamp unit of the present invention is idle.

FIG. 13 shows the internal configuration of the hot stamp unit of the present invention when the hot stamp unit applies pressure (the hot stamping condition).

FIG. 14 shows the positional relationship between the stopper and the stopper lever when the hot stamp unit of the present invention applies pressure.

FIG. 15 shows the positional relationship between the stopper and the stopper lever during the winding of the hologram foil tape.

FIG. 16 shows the positional relationship between the stopper and the stopper lever when the hologram foil tape is completely wound.

FIGS. 17(A) and (B) show tickets as value-added medium. In particular, FIG. 17 (A) is a plan view of a ticket before hot stamping and FIG. 17 (B) is a plan view of a ticket after hot stamping.

FIG. 18 shows the configuration of a stamping portion of the hot stamp unit of the present invention.

FIG. 19 is a perspective view of a dissembled hot stamping portion of the hot stamp unit.

FIG. 20 is a perspective view of a cartridge of the hot stamp unit.

FIG. 21 is a perspective view of a dissembled cartridge of the hot stamp unit.

FIG. 22 is a conceptual diagram showing a hot stamp foil tape inclined in a cartridge.

FIG. 23 is a front view of a winding reel.

FIG. 24 is a side view of a winding reel.

FIG. 25 shows the internal structure of the hot stamp unit of the present invention as viewed from the medium input side.

FIG. 26 is a cross-sectional view of a verifying portion.

FIG. 27 shows the circuit of the verifying portion.

FIG. 28 is a block diagram of the CPU.

FIG. 29 is a conceptual diagram of a network in which the hot stamp unit of the present invention is incorporated.

FIG. 30 is a flowchart for issuing a ticket with hot stamping.

FIG. 31 shows the configuration of another embodiment of the hot stamp unit of the present invention.

FIG. 32 is a conceptual diagram of a self-service station to which the present invention can be applied.

FIGS. 33(A) and (B) show how the second gear of the hot stamp unit of the present invention moves. In particular, FIG. 33 (A) is a conceptual diagram of the condition under which the second gear and the third gear are disengaged during the opposite rotation. FIG. 33 (B) is a conceptual diagram of the condition under which the second and third gears are engaged during the normal rotation.

FIG. 34 is a conceptual diagram showing conventional methods of creating an original document indication.

### DETAILED DESCRIPTION OF THE INVENTION

The configuration of an original document indication device of the present invention is described in detail based on the embodiments illustrated in the figures.

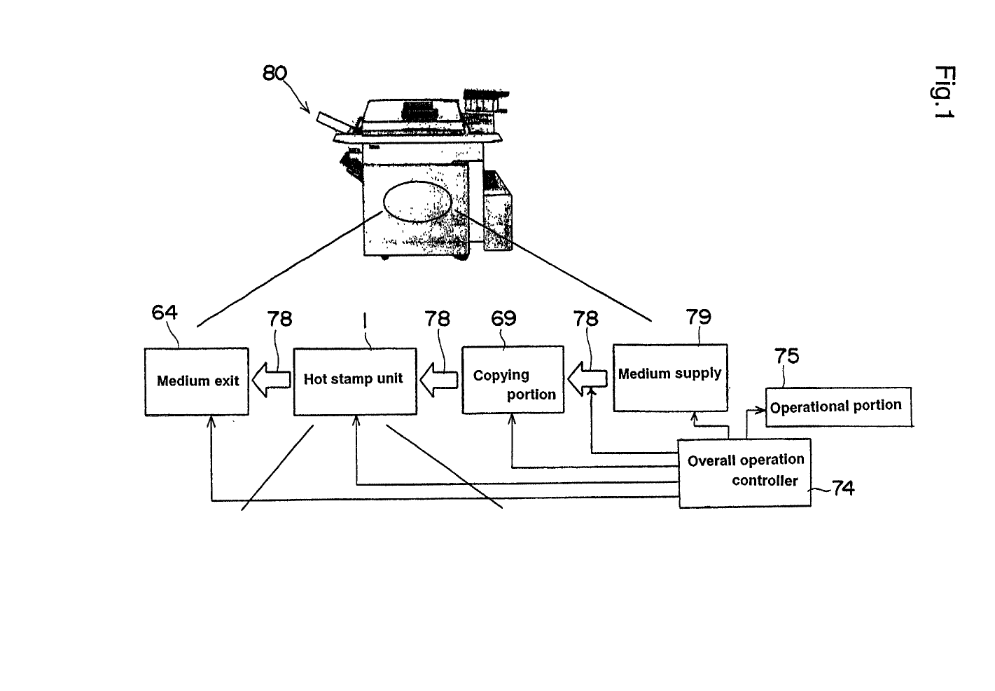

FIGS. 1 through 6 illustrate one embodiment of an original document indication device of the present invention. The original document indication device has not only a simple function of copying or printing a document, but also a function of creating an original document indication with a counterfeit countermeasure transferring portion that is connected to the copying or printing function.

As illustrated in FIG. 1, an original document indication device 80 includes a document creating portion 69 that creates a document on a medium 77 (not illustrated), a counterfeit countermeasure transferring portion 1 that creates an original document indication on the medium 77 when necessary, a transporting means 3 (not illustrated) that transports the medium 77 and an overall operation controller 74 that controls all of these operations based on an input signal from an operating portion 75 (referred to as “operational portion” in FIG. 1). As the medium 77 is transported between the document creating portion 69 and the counterfeit countermeasure transferring portion 1, an original document indication is created.

More specifically, the document creating portion 69 of this embodiment is a copying portion (hereinafter denoted as “copying portion 69”) in the copier in FIG. 1 which duplicates a given document (including drawings and tables) on the medium 77 which is commonly a piece of paper. It should be noted that the document creating portion can be a printer that prints documents created by a word processor, etc. When a printer is used instead of a copier, the above mentioned code, 69, is provided to a printing portion.

As also illustrated in FIG. 1, the original document indication device 80 includes a medium supplying portion 79 in which a blank medium 77 is set, the copying portion 69, a hot stamp unit as the counterfeit countermeasure transferring portion 1 (hereinafter denoted as “hot stamp unit 1”), and a medium exit 64 that ejects out the copied medium 77. Medium 77 is transported among these members by transporting means 78 which is composed of rollers. The operations from the medium supplying portion 79 to the medium exit 64 and the operation of the transporting means 78 are controlled by the overall operation controller 74 which sends operational signals upon receiving a predetermined command that is sent by an operator via the operating portion 75. When a counterfeit countermeasure is needed, an original document indication is stamped during the series of operations. The overall operation controller 74 can command the creation of a document with or without an original document indication depending on the signal from the operating portion 75.

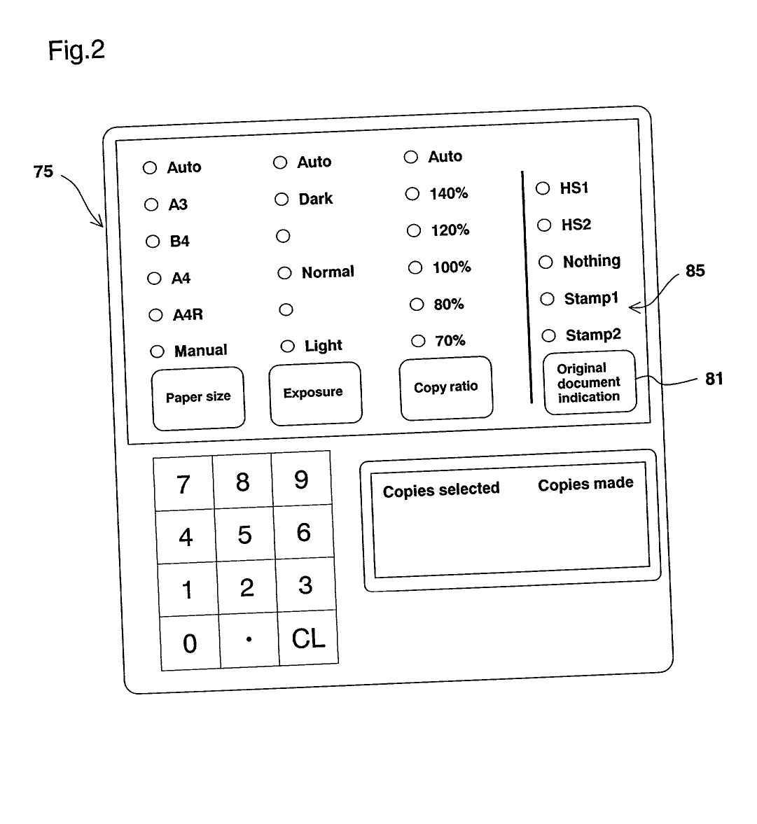

The operating portion 75 is an operation panel provided on an original document indication device 80 as illustrated in FIG. 2. An original document stamping portion 85 is arranged on the right side of the operation panel. As an operator operates an original document indication key 81 to select an option, an original document indication can be stamped. In other words, when the command is sent to create the original document indication, the original document indication device 80 operates the hot stamp unit 1 together with the document creating function so that a counterfeit countermeasure is transferred onto a document being created to provide an original document indication.

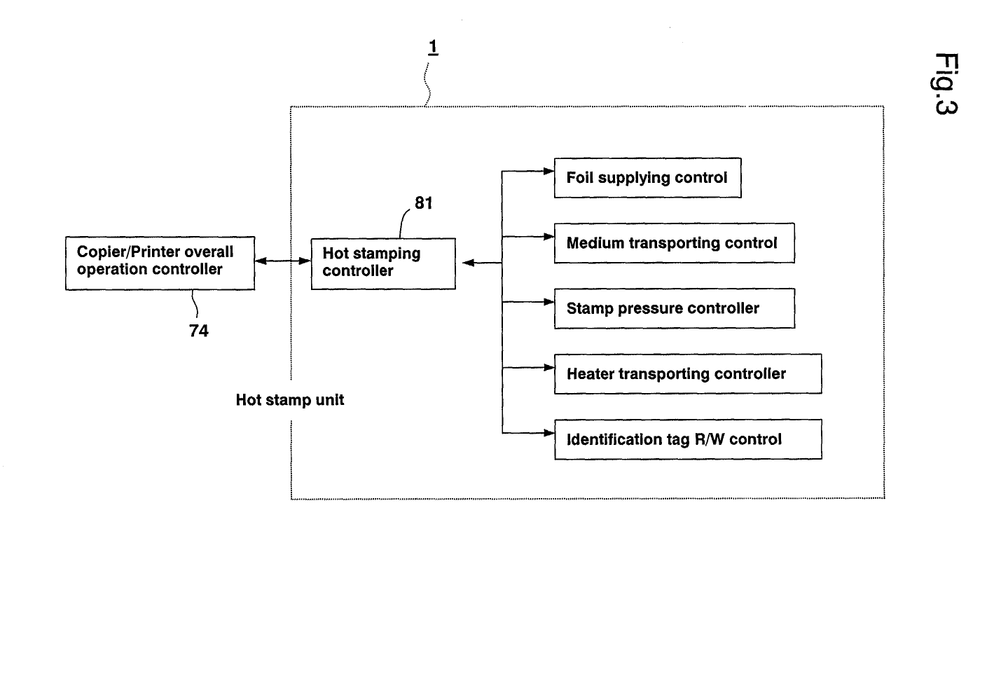

A configuration for a hot stamp unit 1 which is the counterfeit countermeasure transferring portion is described in FIG. 3. The hot stamp unit 1 has a hot stamp operation controlling portion 81 which performs a foil supplying control, a medium transporting control, a stamp pressure control, a heater temperature control and an identification tag R/W (Read/Write) control. The hot stamp operation controlling portion 81 is linked with the copying portion 69 which is connected to the overall operation controller 74, and stamps a predetermined hot stamp foil 4 onto a document being created to create an original document indication.

Furthermore, each time a counterfeit countermeasure is transferred, the overall operation controller 74 may forward the transcription data to an administrative host server (not illustrated) to store the data. It should be noted that the hot stamp operational control unit 81 in addition to the overall operation controller 74 may have the function of forwarding data to an administrative server.

The hot stamp unit 1 may be equipped with a single hot stamp foil tape 4; however, it should preferably contain various kinds of hot stamp foil tapes 4 so that a desired foil can be selected for the stamp. With this, a different original document indication can be stamped according to the type of document to be created. Furthermore, even if the documents are of the same type, a different tag may be given to each of the documents to distinguish the original document indications. To provide a variety of selections for the stamp, the hot stamp foil tape 4 can be equipped with various kinds of foils so that an operator can select a suitable foil for the stamp, or a marks with different shapes and patterns can be stamped during the hot stamping.

Although a hologram foil is preferred as a hot stamp foil tape 4, the tape 4 is not limited to this. A thermal foil medium such as a magnetic foil (magnetic tape) may be used as the tape 4. For example, when a hologram foil is used, a partially transparent foil is hot-stamped on an important statement to prevent the statement from being altered. When the hot stamp foil tape 4 is thermal-transferred, the head position of the hot stamp unit 1 is shifted or the stamp position is determined by the mechanism of the transporting means 78. The hot stamp may be provided to a plurality of spots on the document. Also, the terms such as “original” or “copy” may be covered by the hot stamp foil tape 4 for indication.

Furthermore, it is convenient if the hot stamp unit 1 is of a cartridge type in which a tape-like hot stamp foil tape 4 is contained. Due to the cartridge, there is no need to set up the tape when the hot stamp foil tape 4 is replaced.

In this embodiment, identification codes are provided on the hot stamp unit 1 and on a cartridge 27 so that the replaceable cartridge 27 can be identified with the hot stamp unit 1. In this manner, even when the cartridge 27 is used generally, it can be automatically determined if it is a legal cartridge 27. Therefore, the cartridge 27 is kept from being used in other machines and a counterfeit of an original document indication is prevented as the counterfeit countermeasure is transferred. Also, security of the cartridge use is ensured by obtaining mutual verification between the original document identification device 80 and the cartridge 27 or verification during the copying operation. Also, the distribution of the cartridge 27 can be administered by identifying the tag 83.

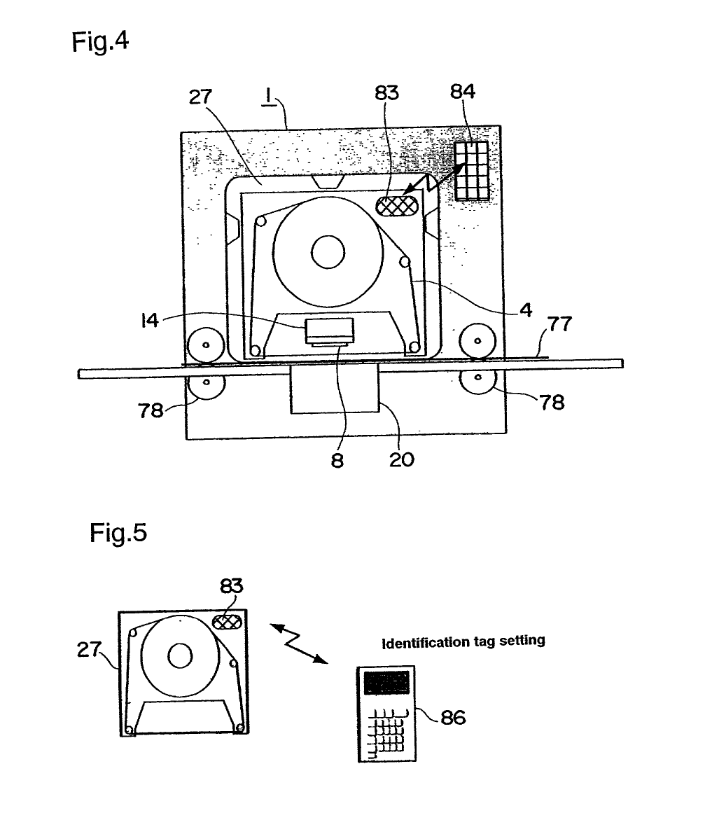

As illustrated in FIG. 4, an identification code consists of an identification tag 83 which is attached to the cartridge 27 and a verifier 84 arranged on the hot stamp unit 1 to identify the cartridge 27 using the identification tag 83. Specifically, the identification code can be composed of a hologram foil, a tag (RF-ID), a bar code, an EEPROM, the biometrics (for finger prints, iris, etc.), or a mechanical unevenness. It should be noted that code data is contained in a particular setting device 86 (See FIG. 5).

The code data contained in the identification code may include not only code data to determine if the cartridge 27 is legal, but also the manufacturing number and the classification number of the cartridge 27, the code of the hot stamp unit 1 in which the cartridge 27 can be used, the code of the original document identification device 80 to which the cartridge 27 can be applied, the code of a specific operator who is allowed to access the cartridge 27 and the usage history of the cartridge 27 (the stamp number, the access limit code, the stamp date and time, the operator account number, the type of the cartridge 27). When the codes of other data are contained in the above manner, the code identification input and the input status thereof can be confirmed on a panel display showing “copies selected” and “copies made” as shown in FIG. 2. Further, the usage history may be transferred to an administrative server (not illustrated) via the overall operation controller 74.

The original document indication key 81 is pressed to select an arbitrary method of creating an original document indication. When the method of creating an original document indication is selected, a lamp next to the selected method on the stamp indicator 85 is lighted.

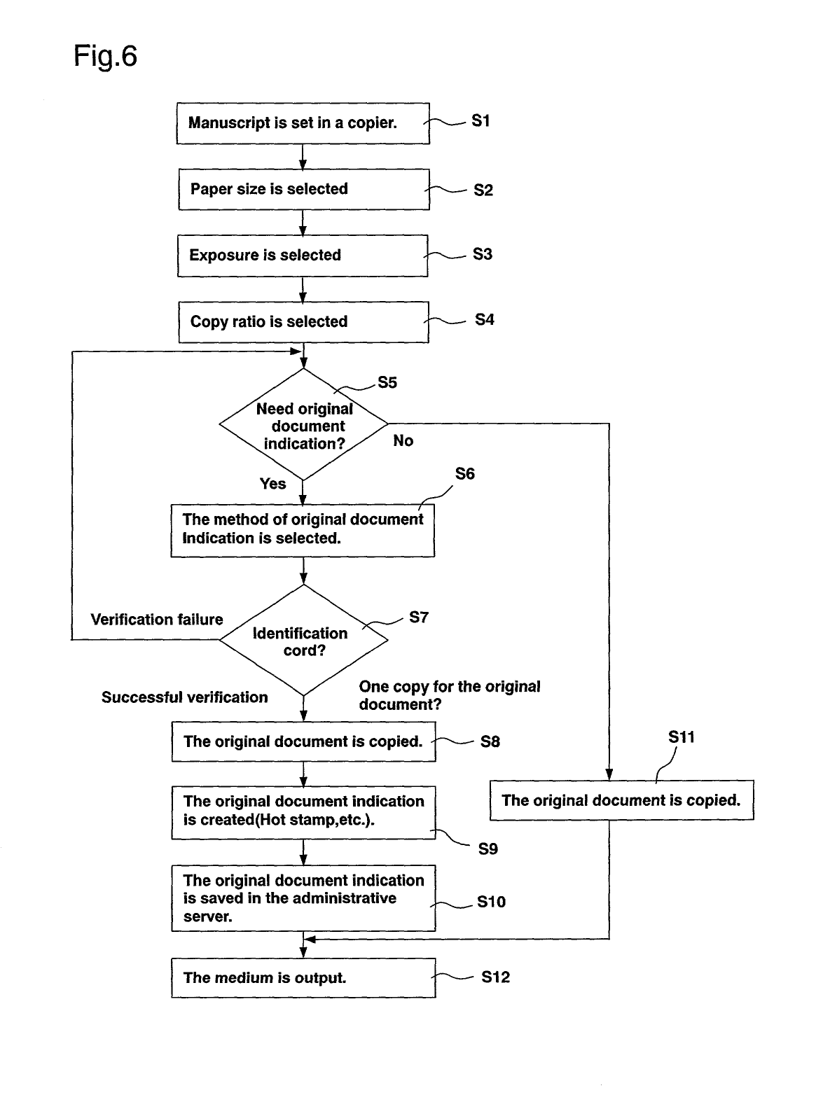

An example of the operation of the above-described original document indication device 80 is described using a flowchart as shown in FIG. 6. In particular, an operator first sets a manuscript in the original document indication device 80 (Step 1), then selects the paper size of the medium 77 (Step 2), and then selects the exposure and copy ratio, if necessary (Steps 3 and 4).

Next, the operator specifies if an original document indication is needed (Step 5). When an original document indication is not needed (i.e., when a normal copy procedure is performed), the process jumps to Step 11 for a normal copy and the medium 77 on which the predetermined document is copied is output through the medium exit 64.

On the other hand, when an original document indication is needed, the original document indication key 81 is pressed to select the original document indication (Step 5), and a method of creating the indication is specified if various methods are available (Step 6). When the identification codes include codes for the hot stamp unit 1 and a specific operator, codes need to be entered for verification (Step 7). With successful verification, creation of an original document indication proceeds. If the verification fails, the operation restarts from the beginning.

In the creation of an original document indication, the copying portion 69 first copies the original document (Step 8), and then the hot stamp unit 1 creates the original document indication. In particular, the hot stamp foil tape 4 with a predetermined pattern and shape is thermally transferred to a predetermined position on a medium 77 as the counterfeit countermeasure. Then, the original document indication data is forwarded to an administrative server (not illustrated) in which the data is recorded (Step 10) and the medium 77 with an original document indication is outputted through the medium exit 64 (Step 12). It should be noted that when the original document indication is selected in the original document indication device 80, the image of the document, the number of pages, the date and time, etc. may be recorded together with the serial number in an administrative server. Although the original document indication is created by the hot stamp unit 1 after the copying portion 69 copies, the copying portion 69 may be operated after the hot stamp unit 1 creates the original document indication.

Thus, in the original document indication device 80 of this embodiment of the present invention, the copying portion 69 as a document creating portion and the hot stamp unit 1 as a counterfeit countermeasure transferring portion are linked to each other to create a document with an original document indication. According to this indication device 80, a document and an original document indication are created on a medium 77 in a series of operations to issue a document with the counterfeit countermeasure. Further, the operations from the beginning of the medium supplying portion 79 to the end, the medium exit 64 are performed in a continuous flow, based on the operational inputs from the operating portion 75. There is no need for the operator to move the medium 77 between the copying portion 69 and the hot stamp unit 1 by hand. Thus, it is a very simple and convenient operation. In addition, the document will not be altered while the document is being created. It is therefore very safe to create an original document with the hot stamp unit 1 of the present invention.

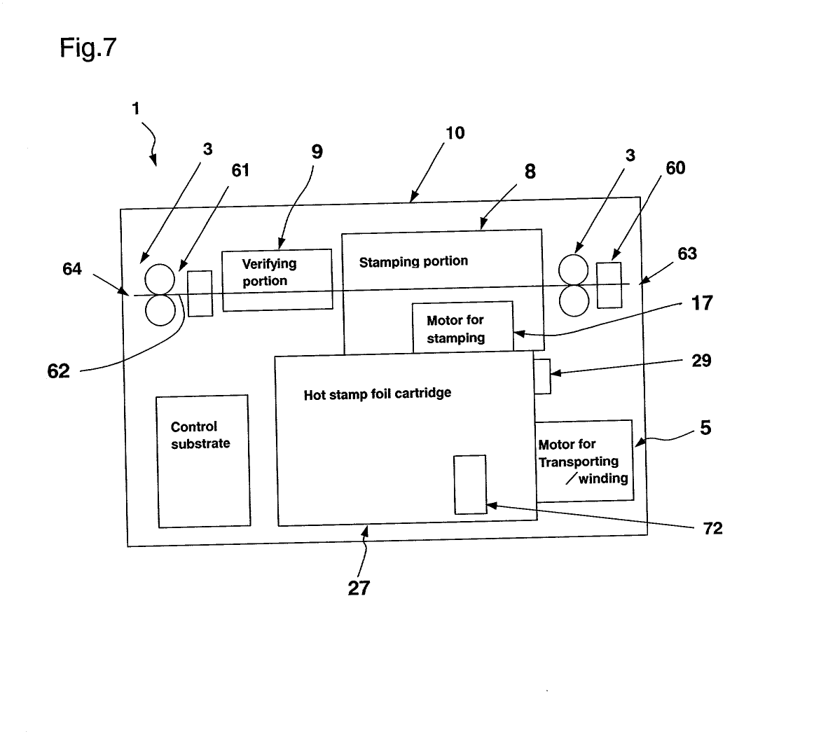

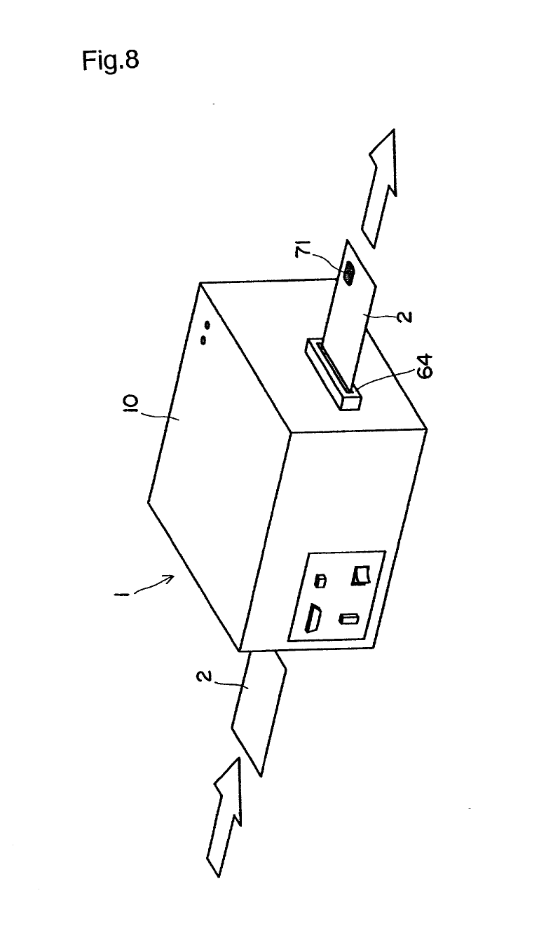

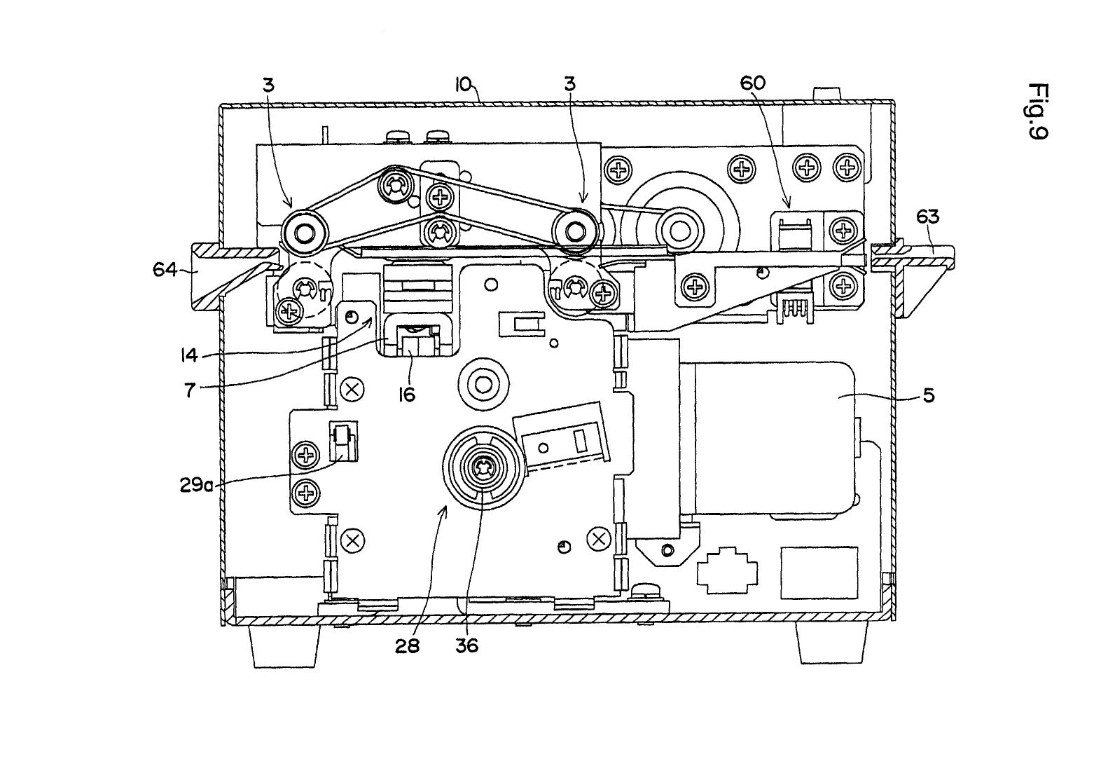

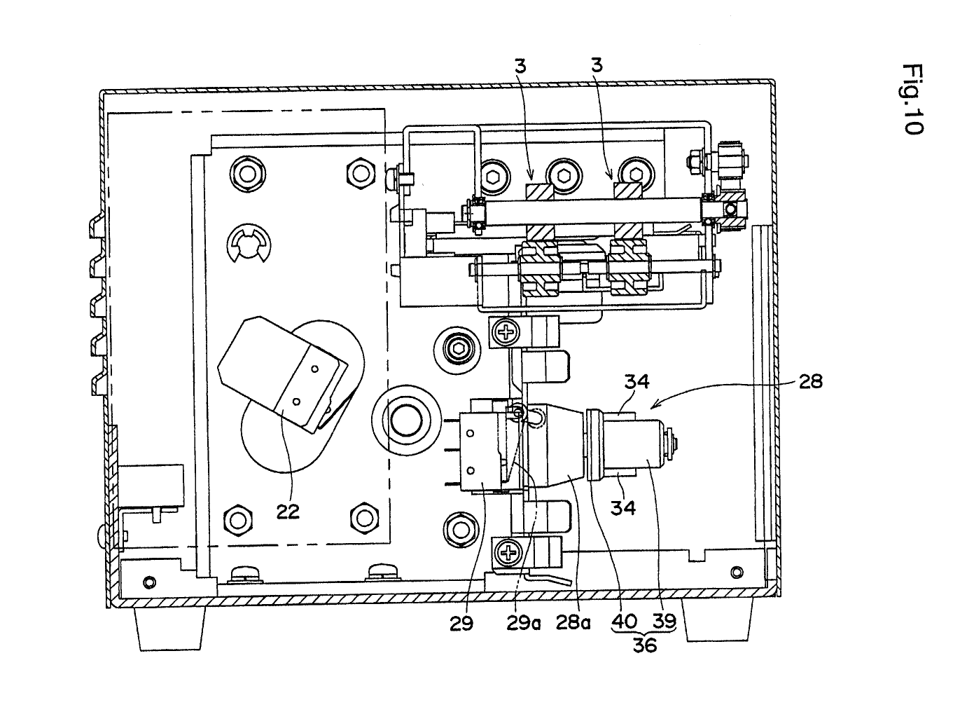

In the above-described embodiment, each of the constituents such as the medium supplying portion 79, the copying portion 69, the hot stamp unit 1 and the medium exit 64 are equipped in a single unit. However, it is not necessary to store all the constituents in a single unit. For example, although the hot stamp unit 1 is not stored in a case of the original document indication device 80, as long as the medium 77 can be automatically transported among the constituents by the transporting means 78, a document with an original document indication can be created through a series of operations in the same manner as the above-mentioned original document indication device 80. In other words, the configuration of the hot stamp unit 1 shown in FIG. 1 can be modified to that shown in FIGS. 7 through 16, in which the hot stamp unit 1 is arranged in a case. The case can be connected with a document creating function such as a copier or a printer to function as an original document indication device. As such, the safety of the hot stamp function is improved.

The present invention also provides for preparing a second original document. A second original document such as a resident card may be issued in such a manner that a first original document is saved in an electronic file and printed according to demand. The printed second original document is sealed to certify the issue. According to an original document indication device 80 of this embodiment, a second original document can be issued as an original document with high security as the convenient printing or copying function is maintained. Therefore, with such an original document indication device 80, it is particularly preferable to print/issue an original document saved in an electronic file.

The configuration of the counterfeit countermeasure transferring portion, which is a constituent of the original document indication device 80, is described hereinafter in detail. As described above, the counterfeit countermeasure transferring portion of this embodiment is composed of a hot stamp unit 1 that thermally transfers a foil onto the medium 77. Considering security issues, the procedure includes first creating a document on the medium 77 and stamping an original document indication using hot stamp unit 1. As shown in FIGS. 7 through 16, hot stamp unit 1 includes a feeding/discharging mechanism 3 for supplying/ejecting the medium 77, that is, a value-added medium (hereinafter denoted as a “value-added medium 2”) on which a document has already been created by the copying portion 69, a winding motor 5 for winding the hot stamp foil tape 4, a stamping portion 8 which has a ceramic heater 6 and an arm 7 and presses the hot stamp foil tape 4 and the value-added medium 2 to transfer the hot stamp foil onto the value-added medium 2, and a verifying portion 9 for confirming the normal stamp condition. A cover 10 covers these constituents to make the hot stamp unit 1. It should be noted that the feeding/discharging mechanism 3 is given a code different from that of the transporting means 78 in an original document indication device 80 to specify that it is an individual member in the hot stamp unit 1. However, the feeding/discharging mechanism 3 has the same function of transporting the value-added medium 2 as the transporting means 78.

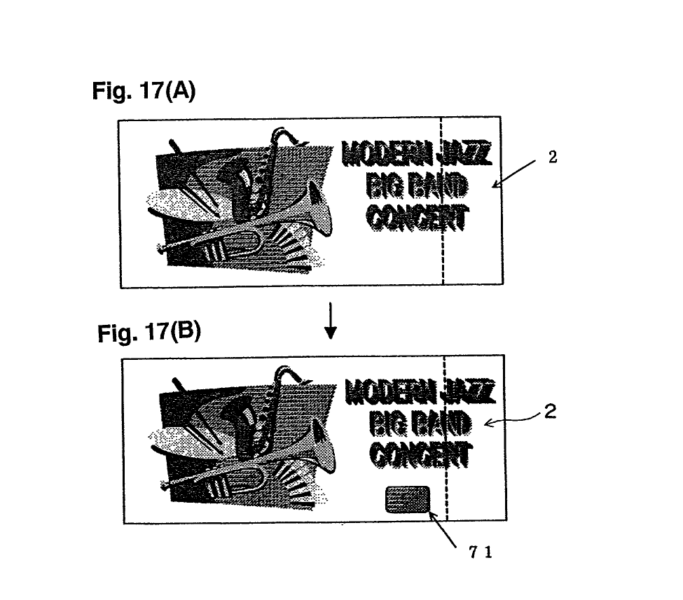

The value-added medium 2 is, for example, a ticket, as illustrated in FIGS. 17(A) and (B). Also, the feeding/discharging mechanism 3 is composed of a transporting roller which is driven by the winding motor 5. In other words, the winding motor 5 is also the driving source of the transporting roller 3, which is the feeding/discharging mechanism 3, and it is denoted as the transporting/winding motor 5 hereinafter.

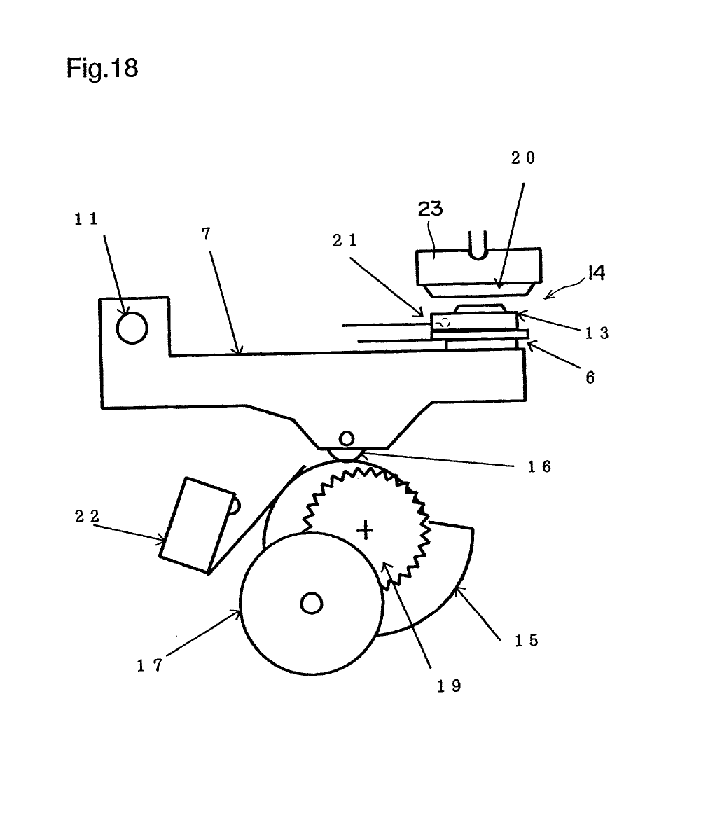

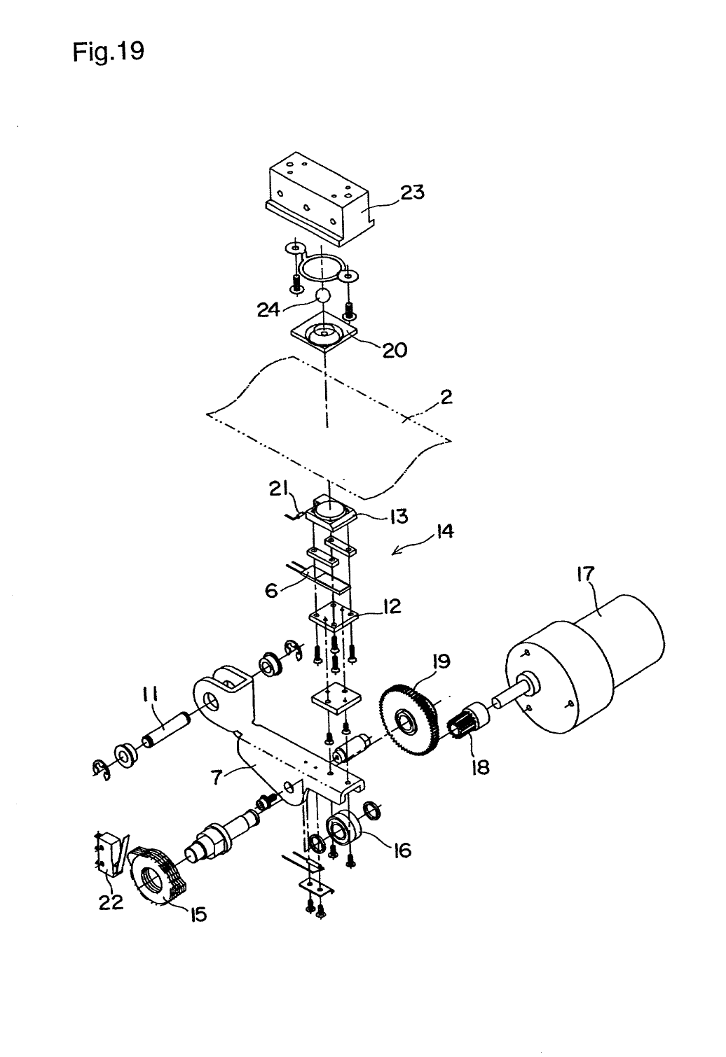

FIGS. 18 and 19 illustrate the stamping portion 8. A heater block 14 consisting of a heat insulating plate 12, a ceramic heater 6 and a hot plate 13 is attached on the front end of the arm 7 that rotates about a support shaft 11. A bearing 16 that rolls against a cam 15 is rotatably attached in the middle of the arm 7. As such, as the rotation of the stamping motor 17 is transmitted to the cam 15 via gears 18 and 19, the arm 7 moves up and down following the contour of the cam 15. Then, the value-added medium 2 and the hot stamp foil tape 4 are sandwiched between the heater block 14 and seating 20 and a large pressure is applied thereto to transfer a hot stamp foil 71 onto the value-added medium 2. The pressure applied at this time is preferably about 30 to 100 kgf/cm² (2.9 to 9.8 Mpa), and the temperature should be preferably about 100 to 140° C. when the value-added medium 2 is a piece of paper. It should be noted that the temperature of the hot plate 13 is detected by a thermostat 21. The rotational angle of the cam 15 that determines the raised and lowered positions of the heater block 14 is detected by a limit switch 22.

Teflon coating is applied to the seating 20 of the stamping portion 8 so that the value-added medium 2 easily detaches. Also, since a block 23 receives repulsion during the transferring, a ball 24 is interposed between the seating 20 and the block 23 to enable the seating 20 to change its angle with respect to the block 23. As such, during the transferring, the angle of the seating 20 can be changed following the angle changes of the heater block 14 attached to the front end of the arm 7 which swings about the support shaft 11. Further, the position of the seating 20 is adjustable in the up-and-down direction according to the thickness of the value-added medium 2.

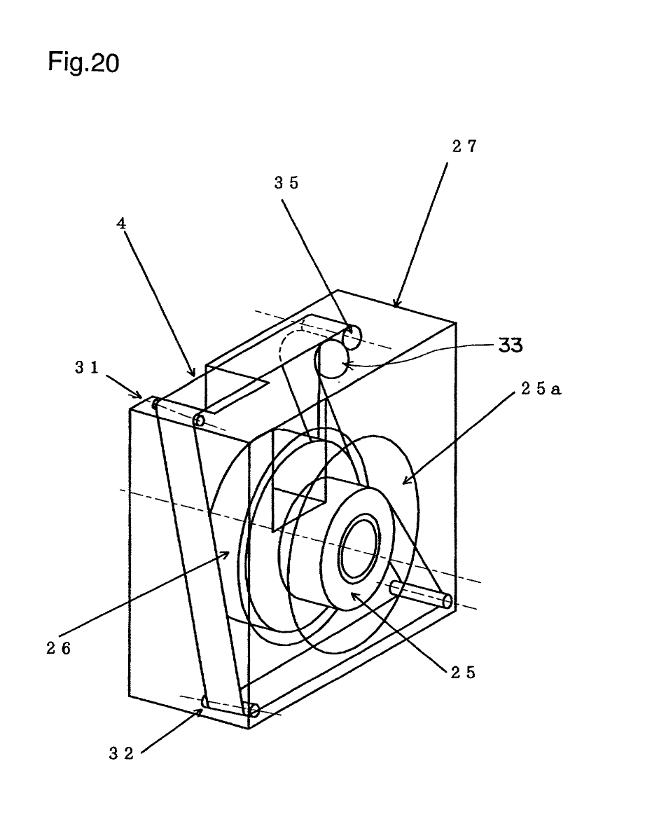

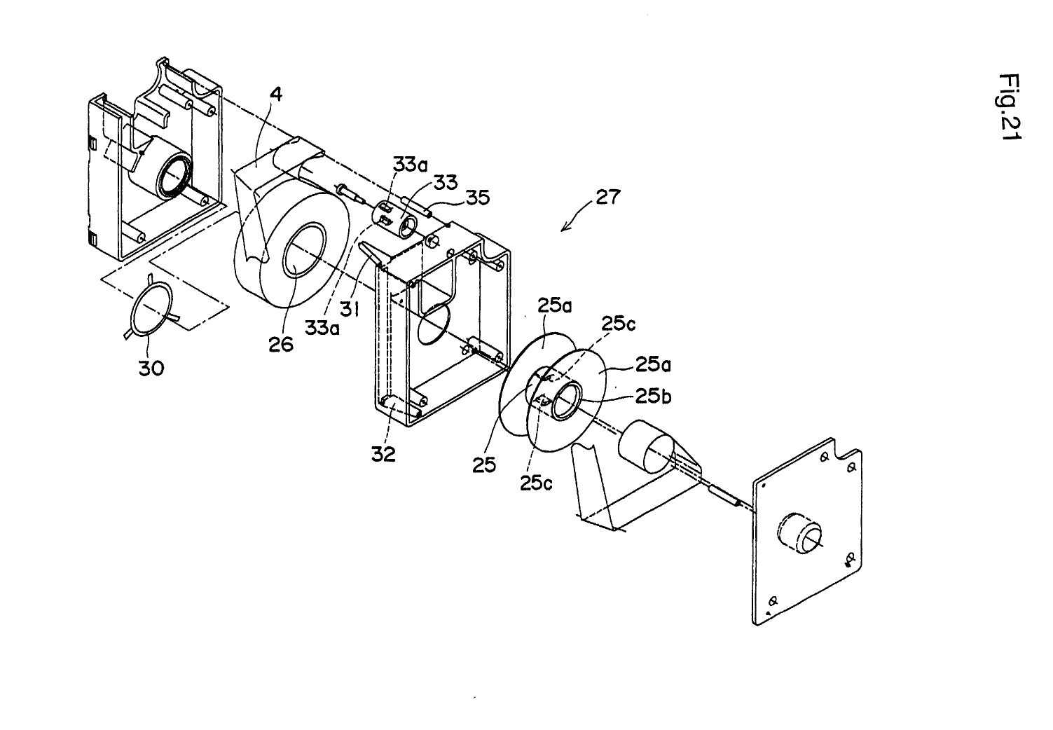

The hot stamp foil tape 4 is stored in a cartridge 27 which is equipped with a winding reel 25 and a feeding reel 26. The hot stamp foil tape 4 does not come out of the cartridge 27. FIGS. 20 and 21 illustrate the cartridge 27. In particular, the cartridge 27 includes the winding reel 25 and the feeding reel 26 for winding and feeding the hot stamp foil tape 4, which are arranged coaxial to a winding shaft 28 of the hot stamp unit 1, an engaging portion 25c which is formed at the winding reel 25 and engaged with the feeding reel 26, a brake mechanism 30 provided at the feeding reel 26, guiding rollers 31 and 32 which are arranged to be inclined to the edge lines of the cartridge 27 by a predetermined angle, and a control roller 33 which is arranged on a path of the hot stamp foil tape 4 so that the foil tape 4 is wound therealong. It should be noted that the hot stamp foil 71 can be, for example, a hologram foil.

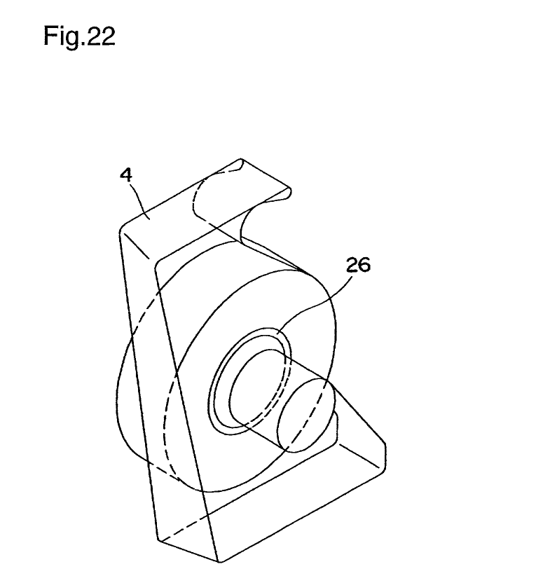

Since the winding reel 25 and the feeding reel 26 are arranged on the same axis, the passageway of the hot stamp foil tape 4 is inclined due to the two guiding rollers 31 and 32 in this embodiment. In other words, the two guiding rollers 31 and 32 are arranged in the cartridge 27 such that they are inclined to the edge lines of the cartridge 27 by a predetermined angle. As guided along the guiding rollers 31 and 32, the hot stamp foil tape 4 moves diagonally so that the feeding reel 26 and the winding reel 25 can be arranged on the same axis (See FIG. 22).

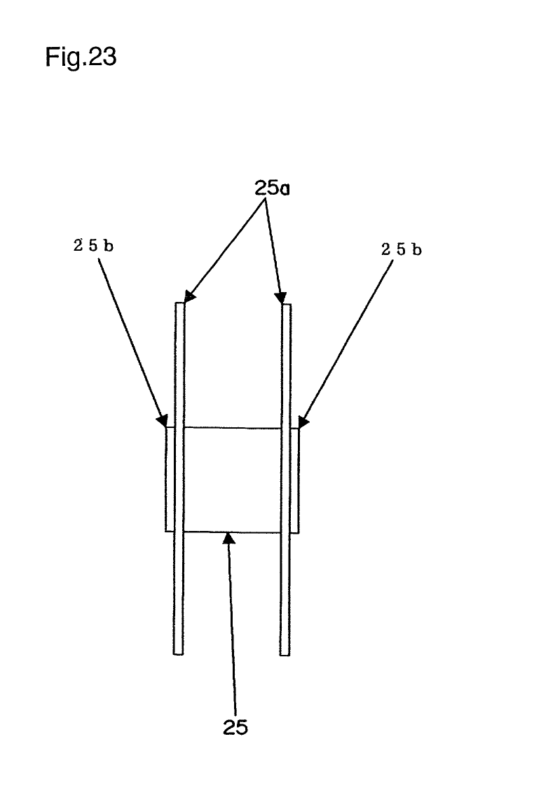

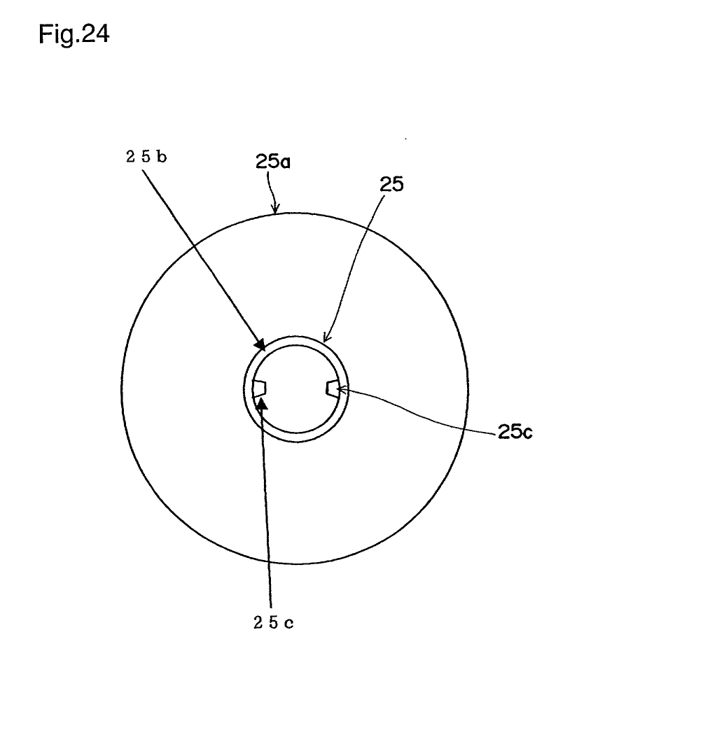

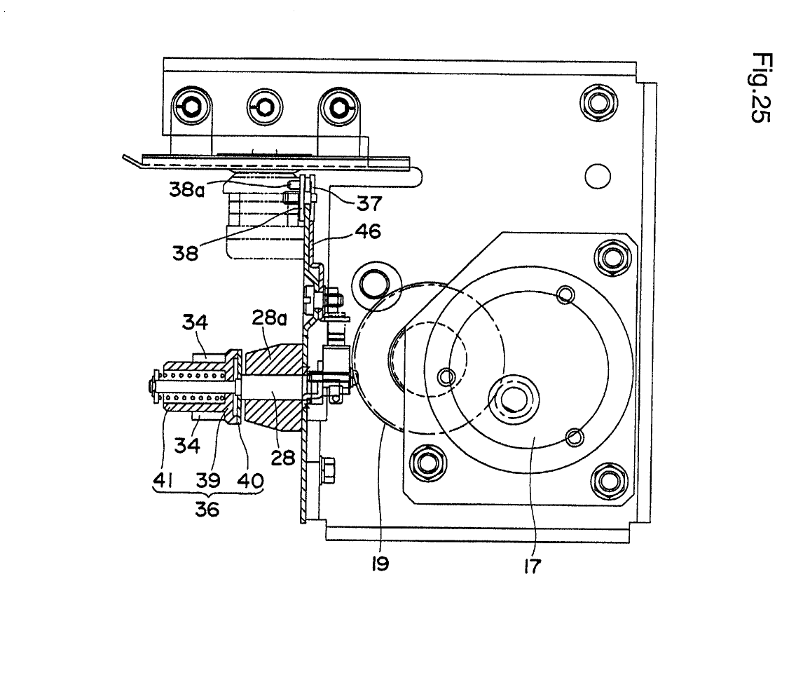

Flanges 25a are provided for the winding reel 25 as illustrated in FIGS. 23 and 24 to prevent friction between the wound-up hot stamp foil tape 4 and the inner surface of the case of the cartridge 27. Also, protrusions 25b are provided on the outside of the winding reel 25. The protrusions 25b are contacted to the case inner surface to prevent friction between the flanges 25a and the case inner surface thereby preventing the frictional force that can be a rotational resistance to the winding reel 25. Consequently, disordered winding can also be prevented. Thus, the tape can be wound up to the end without a jam by a constant torque.

The case of the cartridge 27 can be either opaque or transparent. When the case of the cartridge 27 is fabricated with an opaque resin, the hot stamp foil pattern cannot be seen from the outside. This psychologically discourages an individual to counterfeit the ticket and thus prevents ticket counterfeiting. When the case of the cartridge 27 is fabricated with a transparent resin, it is possible to see from the outside how much tape 4 is left. Therefore, a new cartridge 27 can be prepared before the hot stamp foil tape 4 is completely used. This prevents the loss by stopping the hot stamping operation due to running out of the hot stamp foil tape 4. Also, even when the case of the cartridge 27 is fabricated with an opaque resin, a transparent window may be provided on the side of the feeding reel 26. As such, it is possible to see how much tape 4 is left while the pattern on the hot stamp foil is kept unseen.

The hot stamp foil tape 4 is first stored in the case, and then the cartridge 27 is assembled and sealed by heat welding at a factory. This prevents the legal hot stamp foil tape 4 in the cartridge 27 from being substituted with an illegal one or from being stolen.

The engaging portion 25c is provided at two opposing locations on the inner circumference of the winding reel 25. The engaging portions 25c are engaged with two engaging protrusions 34 on the winding shaft 28 to transmit the rotation of the winding shaft 28 to the winding reel 25.

The control roller 33 is located on a side of the feeding reel 26. The hot stamp foil tape 4 sent by the feeding reel 26 is guided along the control roller 33 from the inside of the cartridge 27 and turned outward; it is further guided along the roller 35 from the outside and turned and pulled toward the guiding roller 31. Therefore, a large frictional force is generated between the control roller 33 and the hot stamp foil tape 4. As the hot stamp foil tape 4 moves, the control roller 33 rotates. Or unless the control roller 33 rotates, the hot stamp foil tape 4 cannot move. Two protrusions 33a are provided on the inner circumference of the control roller 33 to engage with a pin 38a on a rotary body 38 that rotates together with a stopper in the device main body. With this, the control roller 33 can freely rotate within the range of about 180° until the two protrusions 33a are engaged with the pin 38a on the rotary body 38. After the protrusions 33a are engaged with the pin 38a, the control roller 33 cannot rotate any more unless the stopper 37 is rotated.

As described above, the hot stamp foil tape 4 is turned back at the roller 35 due to the control roller 33. Therefore, the hot stamp foil tape 4 moves in opposite directions before and after the roller 35, and therefore, the portions of the tape 4, before and after the roller 35, rub against each other. Since the rubbing portion of the tape is pressed by the control roller 33, with the help of the brake mechanism 30, a rotational resistance is exerted on the feeding reel 26. Consequently, the hot stamp foil tape 4 is tensioned and an idle rotation of the feeding reel 26 is prevented. The brake mechanism 30 is a flat spring attached to the end face of the feeding reel 26 which makes contact with the inner surface of the case of the cartridge 27 to generate a frictional force.

A torque limitter 36 is provided to the winding shaft 28. The torque limitter 36 consists of a holder 39 relatively rotatable to the winding shaft 28, a friction plate 40 united to the winding shaft 28 (so that it is not relatively rotatable to the winding shaft 28) and a spring 41 for pushing the holder 39 toward the friction plate 40. Engaging protrusions 34 are formed on the holder 39 to engage with the engaging portions 25c on the winding reel 25. As the friction plate 40 is engaged by friction with the holder 39, the rotational force of the winding shaft 28 is transmitted to the friction plate 40, the holder 39, the engaging protrusions 34, the engaging portions 25c and the winding reel 25 in this order. When the winding reel 25 cannot rotate, the friction plate 40 rotates idly with respect to the holder 39 to cut off the transmission of the rotational force of the winding shaft 28.

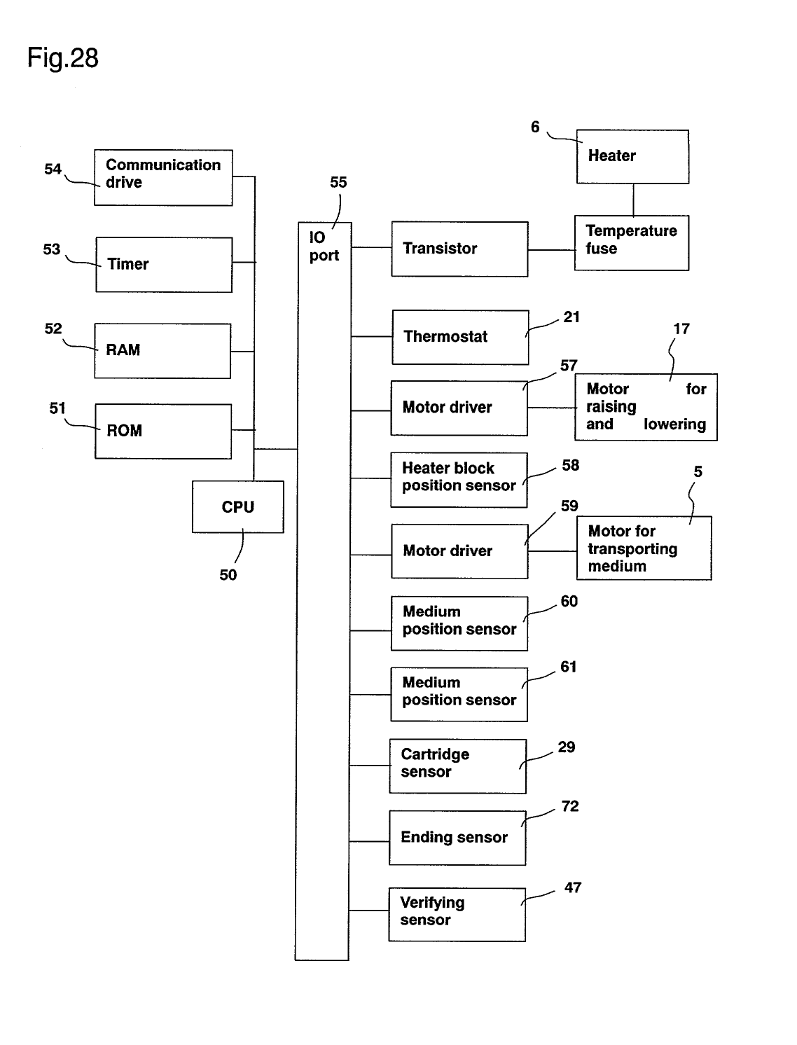

The limit switch 29, acting as a detecting device, is arranged at a location in the hot stamp unit 1 to which the cartridge 27 is installed to detect the presence of the cartridge 27. When the cartridge 27 is installed, the status of the limit switch 29 changes to detect the cartridge 27. As the execution command is sent by the host controller, CPU 50 (See FIG. 28) refers to the status of the limit switch 29. If the cartridge 27 is present, the hot stamp operation is performed. If the cartridge 27 is not present, the hot stamp operation is not performed and a message signal of no cartridge 27 is sent to the host controller.

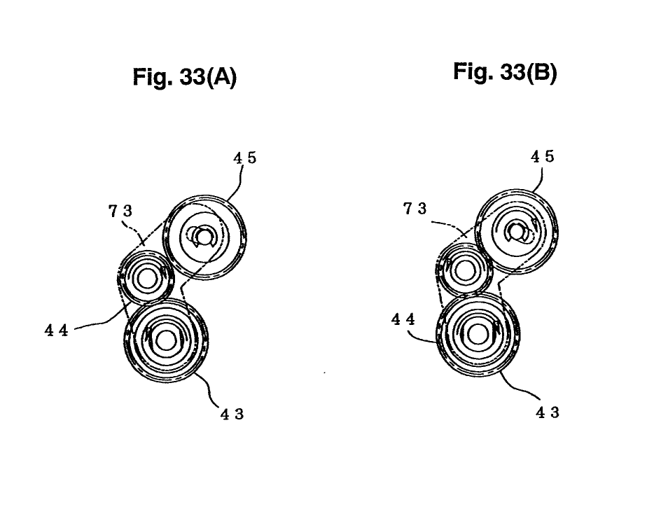

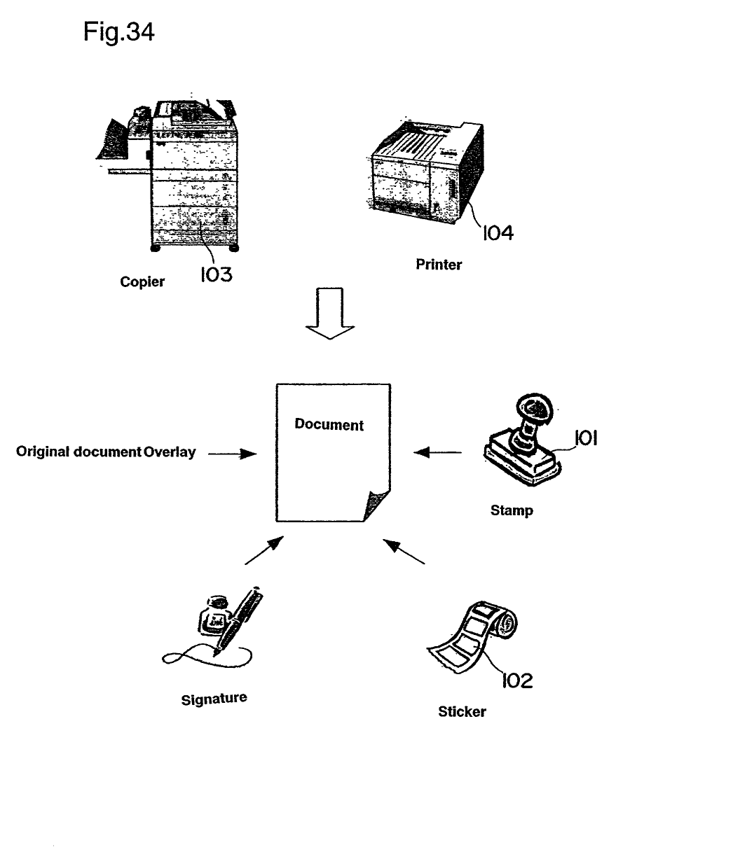

The rotational force of the transporting roller 3 is transmitted to a belt 42, a first gear 43, a second gear 44, a third gear 45 and the winding shaft 28 in this order. The second gear 44 is a run-up gear. When the transporting/winding motor 5 is rotated in the winding direction, the second gear 44 meshes with the third gear 45 to transmit the rotational force. When the motor 5 is rotated in the opposite direction, the second gear 44 escapes from the third gear 45 so that the rotational force is not transmitted. In other words, when the transporting/winding motor 5 is rotated in the opposite direction to transport the value-added medium 2 in the opposite direction due to a hot stamp failure, the second gear 44 escapes from the third gear 45 and thus, the winding shaft 28 is not rotated in the opposite direction. As such, the hot stamp foil tape 4 which has been wound on the winding reel 25 in the cartridge 27 does not become loose thereby preventing a tape jam. It should be noted that the second gear 44 is supported by a lever 73. The lever 73 is turned about the rotational center of the first gear 43 to enable the second gear 44 to move (See FIGS. 33 (A) and (B)).

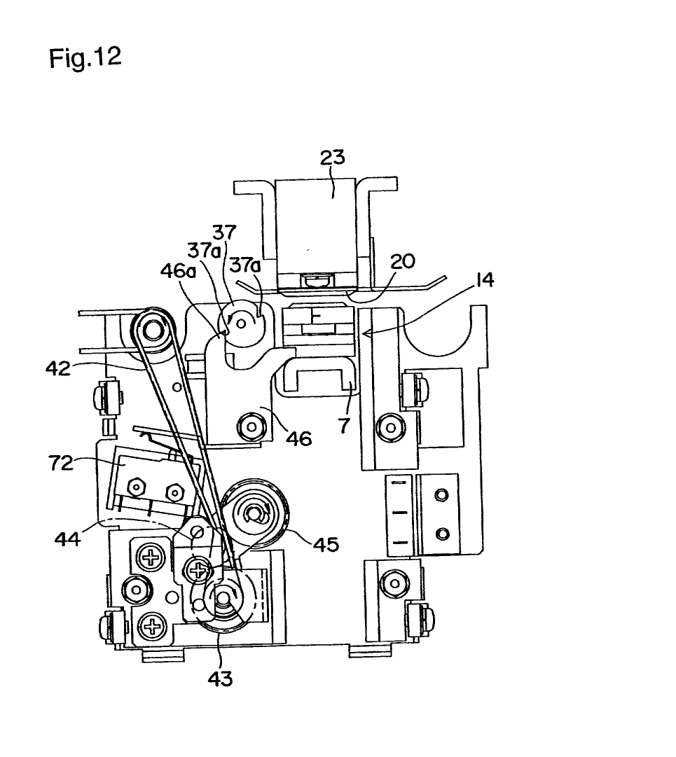

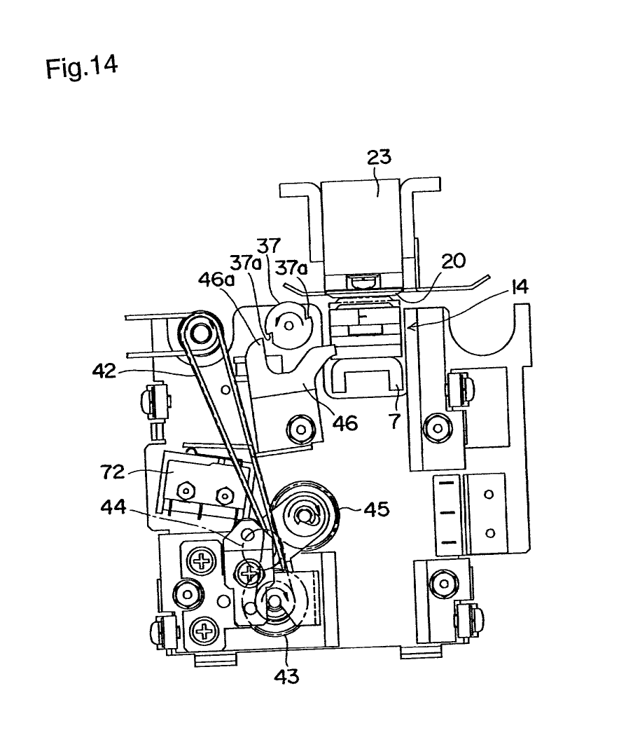

A stopper lever 46 is provided in the hot stamp unit 1 main body to engage with the stopper 37. The stopper lever 46 is moved by the up-and-down movement of the arm 7 between the position shown in FIG. 12 and the position shown in FIG. 14 to turn on and off the limit switch 72. In other words, unless the stopper lever 46 is moved to the upper position (the position of FIG. 12), the limit switch 72 cannot be turned off. When the point 46a of the stopper lever 46 is opposed to a notch 37a, the lever 46 can move to the upper position. Thus, the rotation of the control roller 33 can be detected by the limit switch 72 through the stopper 37 and the stopper lever 46. In other words, the stopper 37, the stopper lever 46 and the limit switch 72 construct a detecting means for detecting the rotation of the control roller 33 to detect the end of the hot stamp foil tape 4. This detecting means also functions as a means for observing the winding condition of the hot stamp foil tape 4 by detecting the rotation of the control roller 33.

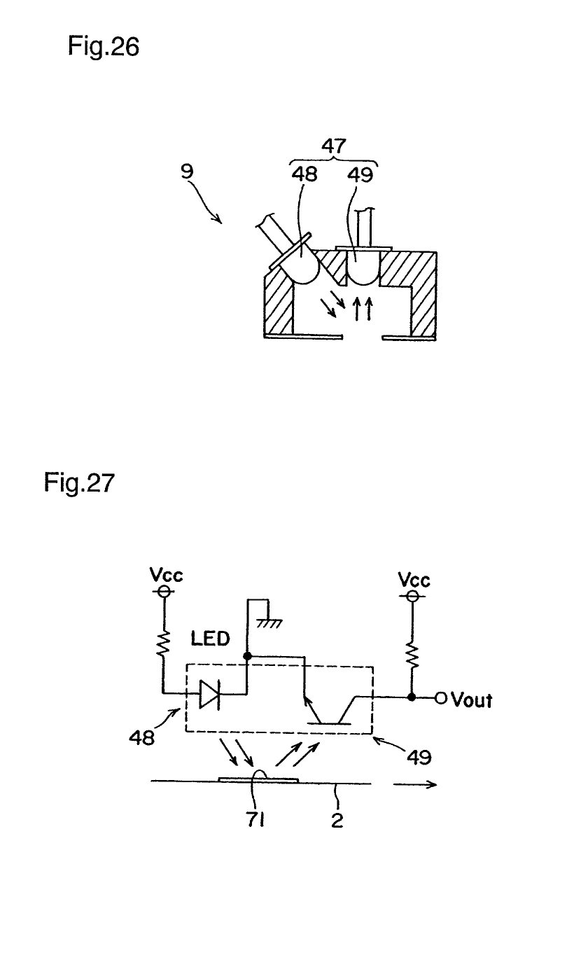

The verifying portion 9 is arranged to face the position-to-be of the hot stamp foil 71 transferred onto the value-added medium 2 which is transported by the transporting roller 3. The verifying portion 9 has a reflective photo emitting/receiving device 47, as shown in FIG. 26, for detecting the optical reflection of the hot stamp foil 71 to detect the position of the hot stamp foil and the reflectance. The reflective photo emitting/receiving device 47 is composed of a reflective photo sensor consisting of a white LED 48 and a photo transistor 49 to detect a reflective light from the hot stamp foil 71 on the surface of the value-added medium 2. The light sensed by the photo transistor 49 is converted into current and then sent as output. The output of the reflective light at this time depends on the luminous energy of the reflective light. For example, the light emitted by the white LED 48 reflects differently on the hot stamp foil which has a high reflectance then that on a paper surface which has a relatively low reflectance.

As shown in FIG. 28, connected to CPU 50 are ROM 51, RAM 52, a timer 53, a communication driver 54 and an IO port 55. In addition, connected to the IO port 55 is a transistor 56 for driving the ceramic heater 6, a thermostat 21 for detecting the temperature of the ceramic heater 6 (hot plate 13), a driver 57 for driving the stamping motor (heater block raising/lowering motor) 17 which raises and lowers the heater block 14, a position sensor 58 for detecting the position of the heater block 14, a motor driver 59 for driving the transporting/winding motor (medium transporting motor) 5 which transports the value-added medium 2 and winds the hot stamp foil tape 4 inside the cartridge 27, a plurality of medium position sensors 60 and 61 for detecting the position of the value-added medium 2, a cartridge sensor (limit switch) 29 for detecting the presence of the cartridge 27, an end sensor (limit switch) 72 for detecting the end of the hot stamp foil tape 4, and a verifying sensor (reflective photo emitting/receiving device) 47 for verifying a normal hot stamp condition. Furthermore, the control can be externally performed by a communication function. On the other hand, the control can be operated independently from a communication function.

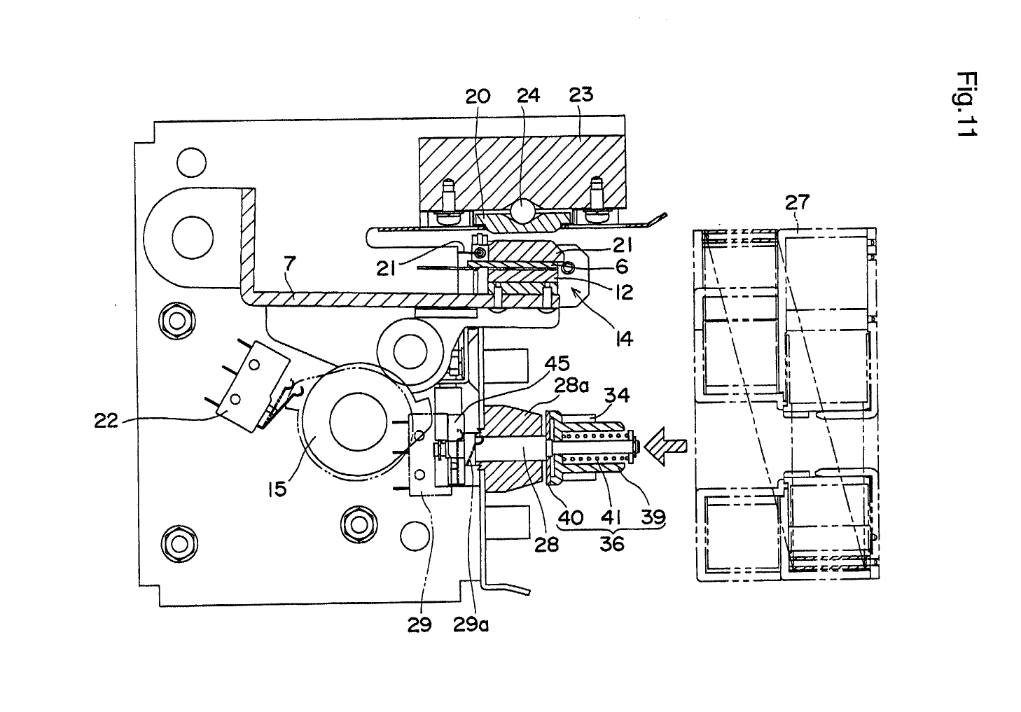

The hot stamp unit 1 configured as described above is operated in the following manner. When the device is idle, the value-added medium 2, the hologram foil (hot stamp foil) tape 4, the heater block 14 and the seating 20 are positioned as illustrated in FIGS. 11 and 12. At this time, the heater block 14 and the seating 20 that perform the hot stamping are away from a medium passageway 62. The ceramic heater 6 is preheated to about 70° C. to 80° C. By preheating the ceramic heater 6 to a temperature in this range, the ceramic heater 6 can be heated in several seconds to about 100° C. which enables hot stamping. Thereby, hot stamping can be promptly performed. Preheating is not a must and thus, the ceramic heater 6 may not be preheated when the energy saving is considered.

Then, as the value-added medium 2 is set in the medium input portion 63, the first medium position sensor 60 is turned on to start the transporting/winding motor 5. As such, the transporting roller 3 is driven to start transporting the value-added medium 2. When the value-added medium 2 is transported to a position at which the second medium position sensor 61 is operable (it can sense), the sensor 61 is turned on and the transporting/winding motor 5 stops. At this position, hot stamping is performed.

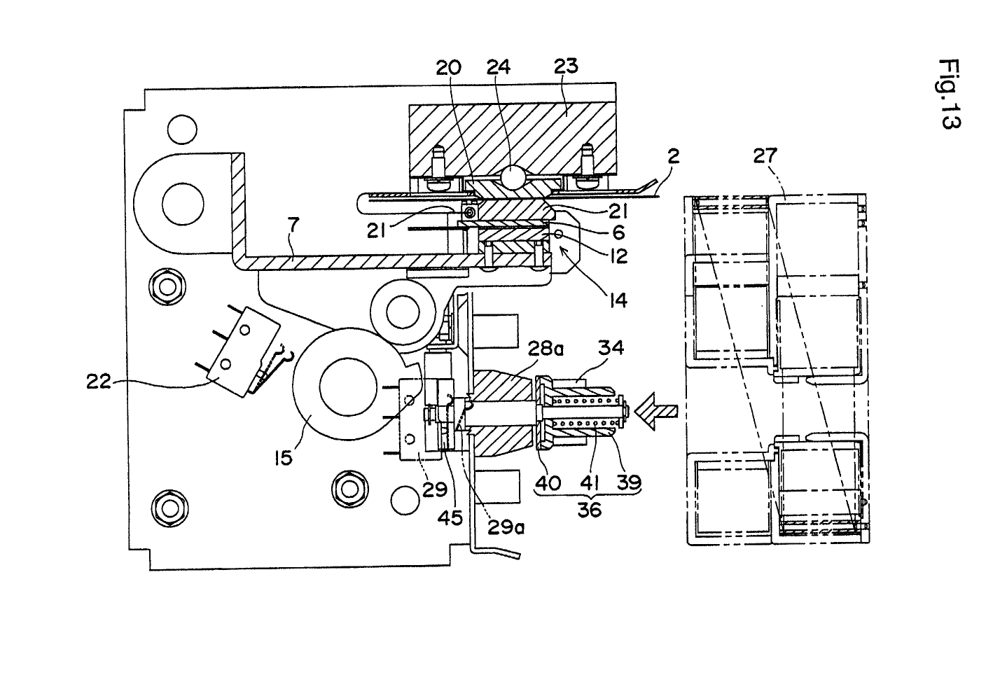

More specifically, the stamping motor 17 is driven to raise the arm 7 via the cam 15 so that the heater block 14 united with the arm 7 is pressed toward the seating 20 on the opposite (upper) side while the hologram foil tape 4 and the value-added medium 2 are sandwiched therebetween (See FIG. 13). Following the upward movement of the arm 7, the stopper lever 46 moves to the position shown in FIG. 14 at which the point 46a thereof escapes from the notch 37a of the stopper 37 and a lower portion thereof activates the limit switch 72.

As the hologram foil is transferred onto the value-added medium 2 through hot stamping by heating and pressing the heater block 14, (See FIG. 17 (B)), the arm 7 begins receding downward as does the heater block which is united with the arm 7. In other words, the heater block 14 recedes from the hologram foil tape 4.

At the very moment the heater block 14 leaves the hologram foil tape 4, the transporting/winding motor 5 starts rotating so that the transporting roller 3 is rotated to start the transportation for outputting the medium. At the same time, the winding shaft 28 begins rotating. In other words, the rotational force is transmitted from the transporting roller 3 via the belt 42 to the first gear 43, the second gear 44 and the third gear 45 to rotate the winding shaft 28, which is connected with a gear 3, and in turn to wind the hot stamp foil tape 4. It should be noted that a mechanism for disconnecting the transmission of the rotational force is provided to prevent the winding shaft from rotating in the opposite direction (in which the wound-up hologram foil becomes loose) when the medium is transported in the opposite direction. The mechanism functions in such a manner that the second and third gears 43 and 44, respectively, come off the engagement only when the transporting roller is rotated in the opposite direction.

Immediately after hot stamping, the hologram foil tape 4 is lightly stuck to the value-added medium 2. When the medium 2 is transported, the hologram foil tape 4 is also pulled by the value-added medium 2 to move together. As pulled by the value-added medium 2, the hologram foil tape 4 is drawn out, and the control roller 33 on which the hologram foil tape 4 is wound is also rotated by the amount that the hologram foil tape 4 is drawn out. As mentioned above, the protrusions 33a of the control roller 33 are engaged with a pin 38a on the rotary body 38. Therefore, the stopper 37 is also rotated by the same amount as the control roller 33 is rotated.

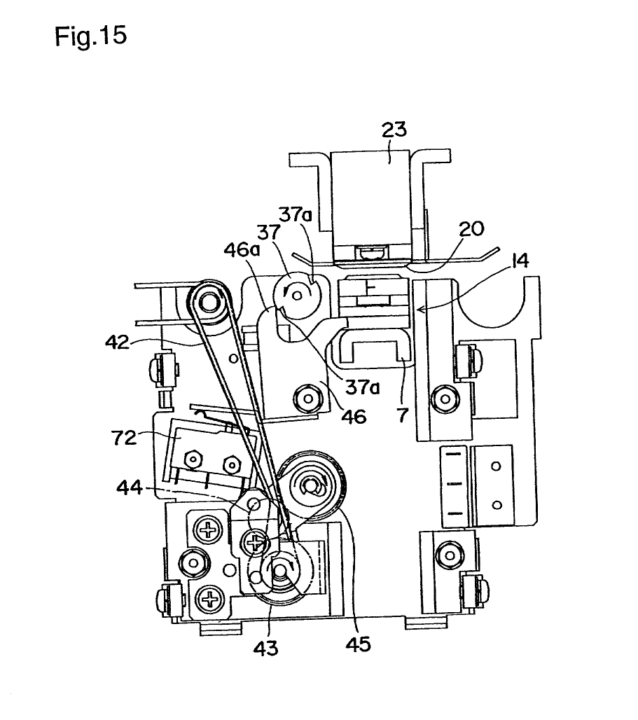

As the arm 7 recedes downward, the stopper lever 46 is turned upwardly by the force of the limit switch 72. At that time, the notch 37a of the stopper 37 comes off the point 46a of the stopper lever 46 with a slight rotation of the control roller 33. Under this condition, the point 46a pushes the stopper 37 so that the stopper 37 remains rotatable as shown in FIG. 15.

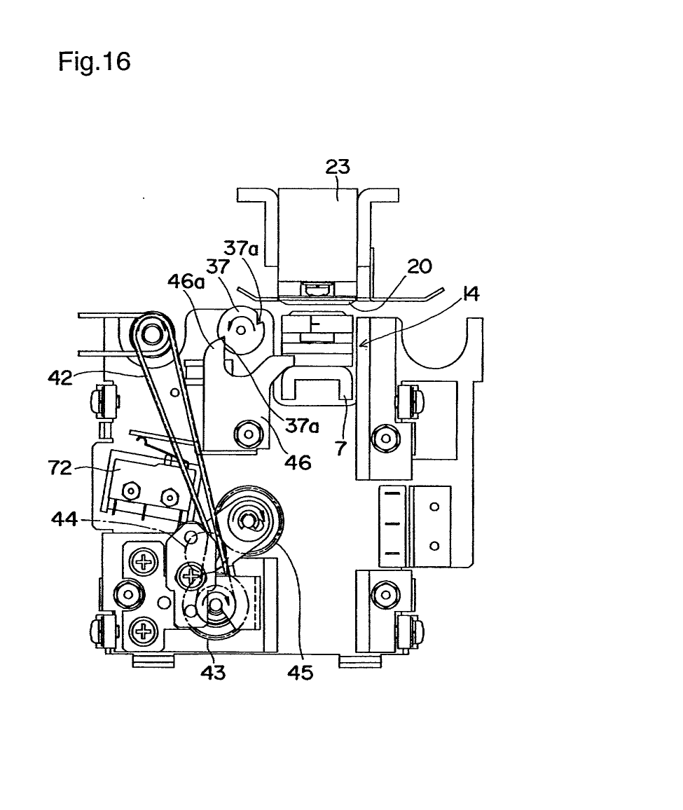

As the hologram winding shaft 28 rotates, the hologram foil tape 4 is continually wound. Since the control roller 33 engaged by friction with the tape 4 is turned by the same amount as the hologram foil tape 4 is drawn out, the stopper 37 is also turned and the point 46a of the stopper lever 46 soon fits into the notch 37a of the stopper 37 to stop the rotation of the stopper 37 and the control roller 33 as shown in FIG. 16.

As the medium is continually transported after the control roller 33 becomes incapable of rotating, the friction plate 40 of the torque limitter 36 rotates idly to cut off the transmission of the winding force to the winding reel 25. More specifically, when the control roller 33 becomes incapable of rotating, the force necessary to wind the hologram foil tape 4 is increased due to the friction resistance between the hologram foil tape 4 and the control roller 33. Consequently, the torque limitter 36 rotates idly to stop winding of the hologram foil tape 4.

In other words, the stopper 37 rotates by about 180°, which is equivalent to the interval between the notches 37a of the stopper 37, from the beginning to the end of the hot stamping operation. The control roller 33 engaged with the stopper 37 is also rotated by about 180°. Consequently, the hologram foil tape 4 is drawn out by half of the circumference of the control roller 33. As such, a new portion of the hologram foil tape 4 is opposed to the stamping portion 8 for the next hot stamping. In this embodiment, the outer diameter of the control roller 33 is determined according to the length of the tape 4 necessary to perform a single hot stamping.

The hot stamping is finished. The verifying portion 9 then confirms whether or not the hot stamp foil 71 is normally transferred. When it is normally transferred, the value-added medium 2 is issued from the medium exit 64. When it is abnormally transferred, the transporting/winding motor is driven in the opposite direction to return the value-added medium 2 to the medium input 63 for discharging.

The detection of the end of the hologram foil tape 4 is described hereinafter. If the hologram foil tape 4 runs out during the hot stamping operation, the control roller 33 cannot be rotated and in turn the stopper lever 46 cannot be raised completely. Thus, the limit switch 72 remains activated (the condition of FIG. 15). Also, when the hologram foil tape 4 is pulled out to the end and the end of the tape 4 is attached by a scotch tape to the feeding reel 26, the tape 4 cannot be drawn out. Consequently, the control roller 33 cannot be rotated and in turn the stopper lever 46 cannot be raised completely. The limit switch 72 stays on in the same manner. Thus, the end of the tape 4 is notified by keeping the limit switch 72 activated.

The detection of the installation of the cartridge 27 is described as follows. As the cartridge 27 is installed, the lever 29a of the limit switch 29 is pushed and the limit switch 29 is turned on. Accordingly, the installation of the cartridge 27 is detected.

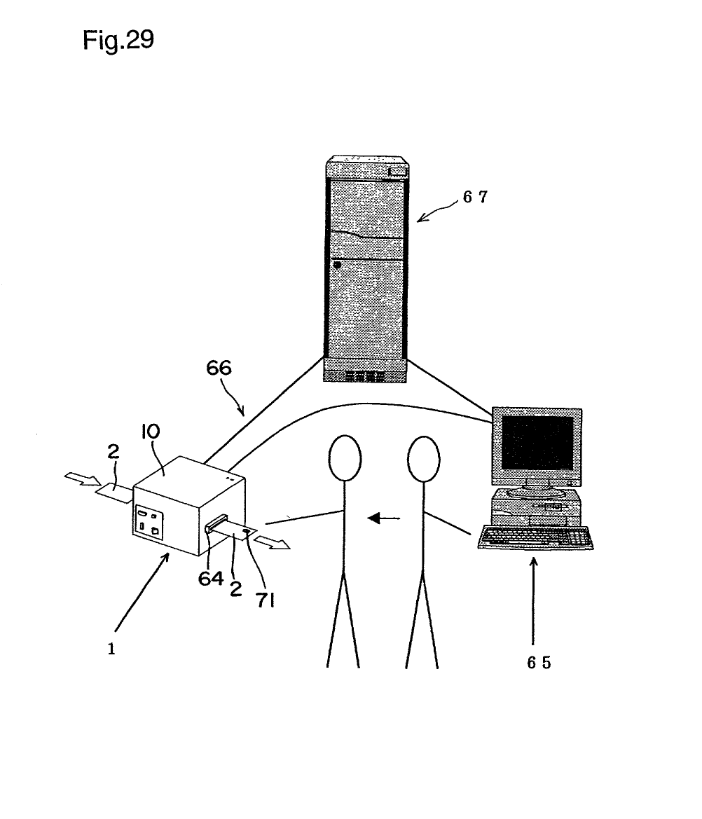

The hot stamp unit 1 of the present invention can also be used in several other ways in the original document indication device 80 of the present invention. As illustrated in FIG. 29, the hot stamp 1 can be used at convenient stores and self-service stations. For example, a store worker or a customer can operate a communication terminal device 65 for payment, and the device 65 communicates with a host server 67 through a network connection 66. With this operation, a hot stamp foil 71 with high security, such as a hologram foil, is stamped on a value-added medium 2 such as a pre-printed ticket or coupon, a verifying portion 9 composed of a reflective photo interrupter confirms a normal hot stamping, and only the value-added medium 2 which has a normal stamp is issued.

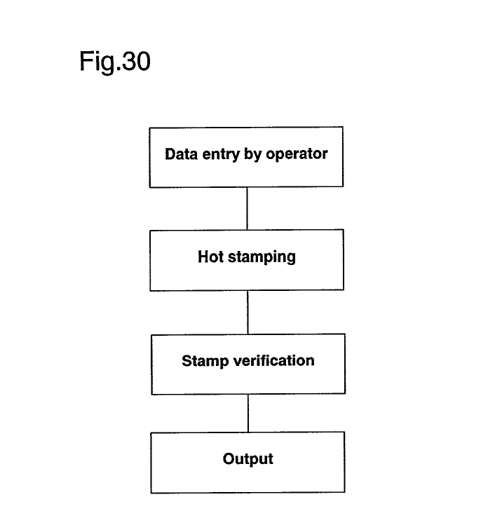

FIG. 30 is a flowchart of such an operation. In this operation, the hot stamp unit 1 is used for performing hot stamping to prevent a counterfeit ticket/coupon from being created using a color copier or a combination of a scanner and a color printer. FIGS. 17(A) and (B) show a value-added medium 2 with a hologram foil stamped.

The hot stamp unit 1 allows an operator to stamp one by one on demand; and therefore makes it possible to issue a ticket/coupon with high security. Thus, counterfeiting is difficult.

Since the hot stamp foil tape 4 is stored in the cartridge 27, the tape can be easily replaced by just replacing the cartridge 27. Also, since the hot stamp foil tape 4 cannot be removed from the cartridge 27 independently, the tape is securely stored, making it difficult to be stolen and counterfeited.

Also, since the sensor (limit switch) 72 is provided for detecting the end of the hot stamp foil tape 4, the end of the tape 4 is signaled to a control center by an operator or through a network.

The cartridge installation sensor (limit switch) 29 can prevent an operator from proceeding the stamping operation under the absence of the hot stamp foil tape 4.

By controlling the temperature and heating time of the ceramic heater 6, hot stamping can be constantly performed under the best conditions. Since the small hot plate 13 and the ceramic heater 6 with a small heat capacity are used, there is no wait time for warming-up. Since the device is small, hot stamping can be performed one by one on demand at a store.

With the verifying portion 9, a document in a poor stamping condition is prevented from printing. This increases security of the printed value-added medium 2.

Since any foil may be used as long as it is stamped by heat and pressure, various security functions can be incorporated in the device to improve security of the document. Decorative gold, silver, neon, and other kinds of foils may be used to add more values on flat media for an entertainment purpose.

The value-added medium 2 for a stamp can be any paper, plastic, etc. as long as it is flat. Therefore, various value-added media 2 can increase the document security.

Since the ceramic heater 6 has a small heat capacity and is heated only when needed, it saves energy and is an environment-friendly device. Also, the feeding reel 26 and the winding reel 25 are coaxially arranged inside the single cartridge 27. This simplifies the replacement. Since the hot stamp foil tape 4 does not come out of the cartridge 27 independently, misuse of the tape 4 can be prevented.

It is also possible to control the winding of the hot stamp foil tape 4 by a predetermined amounts. Therefore, the tape 4 is not excessively wound and can be used efficiently. The end of the hot stamp foil tape 4 is detected automatically to prevent any hot stamping operation when the tape 4 is absent.

Furthermore, the winding shaft 28 can rotate only in the winding direction. For this reason, even when the operation fails and the roller is rotated in the opposite direction to eject the value-added medium 2, the hot stamp foil tape 4 does not become loose inside the cartridge 27, but it is still possible to wind the hot stamp foil tape 4 with tension. This prevents a tape jam.

Moreover, the flanges 25a are provided on the winding reel 25 to prevent the tape from a disordered winding. The constant winding force prevents the device from causing a jam.

It should be noted that although the above embodiment is a preferred example of the present invention, the present invention is not limited to this embodiment and the above embodiment can be modified as within the scope of the present invention. For example, the value-added medium 2 which is a ticket in the above embodiment can also be a credit card. In such a case, the hologram foil 71 is hot-stamped on the credit card 2 at the final step in the credit card issuing device.

A magnetic strip may be attached as the hot stamp foil 71 on which the magnetic data is written to record the operator information and improve security. A signature foil, which is used on the back of a credit card, may be stamped as the hot stamp foil 71. The hot stamp foils 71 of different kinds, such as a hologram foil, a magnetic strip, etc., may be stamped by the single hot stamp unit 1. The hologram foil, the magnetic strip and the signature foil may be operated as the hot stamp foil in the single hot stamp unit 1.

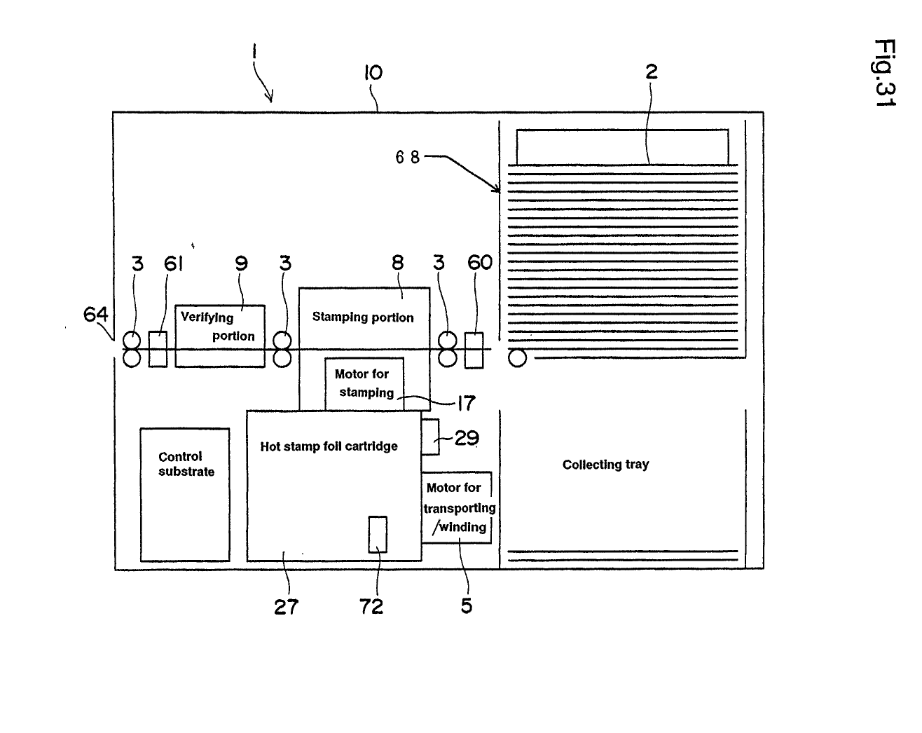

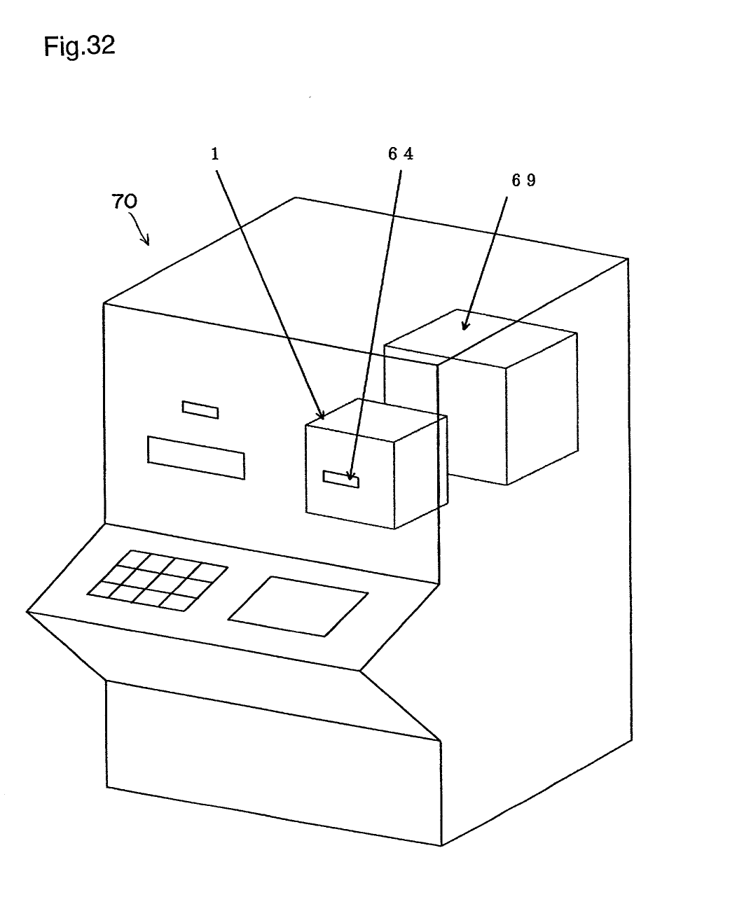

After the magnetic data is written on the magnetic strip of a card (medium), the hologram foil 71 may be attached onto the card (medium). As illustrated in FIG. 31, a stacker 68 may be provided to store hot stamp media by stacking the hot stamp media.

As illustrated in FIG. 32, the hot stamp unit may be installed at a secondary processing portion in a ticket/coupon printing device (printer unit) 69 of a self-service station to stamp the hologram foil onto the printed value-added medium 2 and to eject the value-added medium 2 to the operator. In other words, a self-service station 70 which is equipped with the automatic ticket/coupon issuing device includes a feeding/ejecting mechanism 3 for feeding/ejecting a value-added (printed) medium 2, a winding motor 5 for winding a hot stamp foil tape 4, a stamping portion 8 which has a ceramic heater 6 and an arm 7 and which presses the hot stamp foil tape 4 and the value-added medium 2 to transfer the hot stamp foil onto the value-added medium 2, and a verifying portion for verifying the hot stamp condition.

The above-mentioned hot stamp unit 1 can also be installed in a card issuing device. More specifically, a card issuing device, which is equipped with a feeding/ejecting mechanism 3 for feeding/ejecting a card (a value-added medium), a data reading/writing portion (magnetic head, IC head, etc.), an embosser for marking embossed letters on the card, and a communicator with a host server, includes a winding motor 5 for winding the hot stamp foil tape 4, a stamping portion 8 which has the ceramic heater 6 and the arm 7 and which presses the hot stamp foil tape 4 and the card to transfer the hot stamp foil onto the card, and a verifying portion 9 for verifying the stamping condition.

As is also understood from the above description, a document creating portion and a counterfeit countermeasure transferring portion are linked for operation with the command from the controlling portion, a paper is transported in a series of operations and an original document indication is stamped by the counterfeit preventing means during the operation from the document copying to the ejecting in a printer or a copier to issue a document with an original document indication. Therefore, a counterfeit countermeasure can be stamped on demand to issue a document with an original document indication while retaining the convenient basic function of a printer or copier. Consequently, a document with an original document indication, with which it is difficult to counterfeit or duplicate the document, can be easily created along with a copier or printer.

Thus, the present invention provides for an original document indication device in which a document and an original document indication can be created in a series of operations, such as the document printing and the thermal transferring of a foil or the like by hot stamping. Further, when the hot stamp unit is of a cartridge type, the foil can be replaced by changing the cartridge. This is simple and convenient.

Also in the original document indication device, the authenticity of the cartridge is determined through verification between the device and the cartridge or verification during the operation of the copier. The verification is performed according to the identification codes on the cartridge and on the hot stamp unit. Thus, high security can be obtained.

In the hot stamp unit of the present invention, a cartridge with an identification code is used and the authenticity thereof can be verified. Also, the hot stamp unit can be used as a counterfeit countermeasure transferring portion in the original document indication device. Therefore, the hot stamp unit can identify the replaceable cartridge to automatically determine if a legal cartridge is properly used. This prevents the legal cartridge from being used in illegal machines and the original document indication from being counterfeited during the counterfeit countermeasure transferring. Security can be obtained through verification between the original document indication device and the cartridge or verification during the copying operation. Also, distribution of the cartridge can be administered by identifying the identification code such as the identification tag.

The present invention also provides for an original document indication device in which a second original document is created from a first original document saved in an electronic file. Thereby, the first original document saved in the electronic file can be printed on demand and the printout is sealed to certify the issue. As such, the convenient function of a printer or a copier can be used and an original document with high security can be issued.

What is claimed is:

1. An original document indication device comprising:
a document creating portion for creating a document on a medium;
a counterfeit countermeasure transferring portion for creating an original document indication on the medium;
a transporting means for transporting the medium; and
a controlling portion for controlling operation of the document creating portion, the counterfeit countermeasure transferring portion and the transporting means based on signals input from an operating portion;
wherein the original document indication is created as the medium is transported by the transporting means through the document creating portion and the counterfeit countermeasure transferring portion.

2. An original document indication device according to claim 1, wherein the counterfeit countermeasure transferring portion comprises a hot stamp unit comprising a cartridge.

3. An original document indication device according to claim 2, wherein the hot stamp unit further comprises identification codes.

4. An original document indication device according to claim 1, wherein a first original document is created and is saved in an electronic file and a second original document is created from the first original document.

5. A hot stamp unit comprising a cartridge having identification codes with which the authenticity of the cartridge can be verified wherein the hot stamp unit can be used as a counterfeit countermeasure transferring portion in an original document indication device.

6. An original document with an original document indication produced by using an original document indication device comprising:
a document creating portion for creating a document on a medium;
a counterfeit countermeasure transferring portion for creating an original document indication on the medium;
a transporting means for transporting the medium; and
a controlling portion for controlling operation of the document creating portion, the counterfeit countermeasure transferring portion and the transporting means based on signals input from an operating portion;
wherein the original document indication is created as the medium is transported by the transporting means through the document creating portion and the counterfeit countermeasure transferring portion.

7. A method for preparing an original document with an original document indication comprising using an original document indication device comprising:
a document creating portion for creating a document on a medium;
a counterfeit countermeasure transferring portion for creating an original document indication on the medium;
a transporting means for transporting the medium; and
a controlling portion for controlling operation of the document creating portion, the counterfeit countermeasure transferring portion and the transporting means based on signals input from an operating portion;
wherein the original document indication is created as the medium is transported by the transporting means through the document creating portion and the counterfeit countermeasure transferring portion.
